(19) United States
(12) Patent Application Publication
(10) Pub. No.: US 2026/0001318 A1
(43) Pub. Date: Jan. 1, 2026

(54) LIQUID EJECTING APPARATUS AND DRIVE DEVICE

(71) Applicant: SEIKO EPSON CORPORATION, Tokyo (JP)

(72) Inventors: Yoichiro KONDO, Chino (JP); Toru MATSUYAMA, Matsumoto (JP)

(21) Appl. No.: 19/246,824

(22) Filed: Jun. 24, 2025

(30) Foreign Application Priority Data
Jun. 26, 2024 (JP) 2024-102519

(51) Int. Cl. B41J 2/045; B41J 2/14; B41J 29/377

(52) U.S. Cl. CPC B41J 2/0455; B41J 2/04541; B41J 2/04581; B41J 2/04588; B41J 2/14233; B41J 29/377; B41J 2002/14491

(57) ABSTRACT

A liquid ejecting apparatus includes a liquid ejecting head that is driven by a first drive signal to eject a liquid, an analog conversion circuit that converts a digital first waveform signal designating a waveform of the first drive signal into an analog second waveform signal designating the waveform of the first drive signal, a first transistor pair that includes two bipolar transistors generating the first drive signal based on the second waveform signal, a first cooling mechanism that cools the first transistor pair, and a second cooling mechanism that cools the analog conversion circuit.

The present application is based on, and claims priority from JP Application Serial Number 2024-102519, filed Jun. 26, 2024, the disclosure of which is hereby incorporated by reference herein in its entirety.

### BACKGROUND

### 1. Technical Field

The present disclosure relates to a liquid ejecting apparatus and a drive device.

### 2. Related Art

A liquid ejecting apparatus including a liquid ejecting head that ejects a liquid such as ink in response to a drive by a drive signal, and a drive signal generation circuit that supplies the drive signal to the liquid ejecting head is known. For example, JP-A-2018-099852 discloses a liquid ejecting apparatus provided with a drive signal generation circuit that includes an analog conversion circuit designating a waveform of a drive signal and a transistor pair generating a drive signal based on an output from the analog conversion circuit.

The drive signal for driving the liquid ejecting head is a signal having a large amplitude, and the transistor pair generates heat when generating the drive signal. When the drive signal generation circuit generates the drive signal, heat generated by the transistor pair may propagate to the analog conversion circuit and the analog conversion circuit may have high temperature. Therefore, when the drive signal generation circuit generates the drive signal, there is a possibility that the operation of the analog conversion circuit is unstable.

### SUMMARY

According to an aspect of the present disclosure, there is provided a liquid ejecting apparatus including a liquid ejecting head that is driven by a first drive signal to eject a liquid, an analog conversion circuit that converts a digital first waveform signal designating a waveform of the first drive signal into an analog second waveform signal designating the waveform of the first drive signal, a first transistor pair that includes two bipolar transistors generating the first drive signal based on the second waveform signal, a first cooling mechanism that cools the first transistor pair, and a second cooling mechanism that cools the analog conversion circuit.

According to another aspect of the present disclosure, there is provided a drive device that supplies a first drive signal to a liquid ejecting head driven by the first drive signal to eject a liquid, the drive device including an analog conversion circuit that converts a digital first waveform signal designating a waveform of the first drive signal into an analog second waveform signal designating the waveform of the first drive signal, a first transistor pair that includes two bipolar transistors generating the first drive signal based on the second waveform signal, a first cooling mechanism that cools the first transistor pair, and a second cooling mechanism that cools the analog conversion circuit.

### BRIEF DESCRIPTION OF THE DRAWINGS

FIG. 1 is a block diagram illustrating an example of a configuration of an ink jet printer according to an embodiment of the present disclosure.

FIG. 2 is a perspective view illustrating an example of a schematic internal structure of the ink jet printer.

FIG. 3 is a cross-sectional view illustrating an example of a structure of an ejecting portion.

FIG. 4 is a block diagram illustrating an example of a configuration of a liquid ejecting unit.

FIG. 5 is a timing chart illustrating an example of a signal supplied to the liquid ejecting unit.

FIG. 6 is an explanatory diagram illustrating an example of an individual designation signal.

FIG. 7 is a block diagram illustrating an example of a configuration of a drive signal generation circuit.

FIG. 8 is an exploded perspective view illustrating an example of a structure of a drive control unit.

FIG. 9 is a plan view illustrating an example of the component disposition on a transistor substrate.

FIG. 10 is a cross-sectional view illustrating an example of a structure of the drive control unit.

FIG. 11 is an explanatory diagram illustrating thermal conductivities and specific gravities of various metals.

FIG. 12 is a block diagram illustrating an example of a configuration of a drive signal generation circuit according to Modification Example 3 of the present disclosure.

FIG. 13 is a block diagram illustrating an example of a configuration of an ink jet printer according to Modification Example 4 of the present disclosure.

### DESCRIPTION OF EMBODIMENTS

Hereinafter, an embodiment for performing the present disclosure will be described with reference to the drawings. However, in each figure, the dimensions and scale of each part are appropriately different from the actual ones. In addition, since the embodiment described below is suitable specific examples of the present disclosure, various technically preferable limitations are added, and the scope of the present disclosure is not limited to these embodiments unless otherwise stated in the following description to particularly limit the present disclosure.

### A. EMBODIMENT

Hereinafter, a liquid ejecting apparatus will be described using an ink jet printer 1 that ejects ink to form an image on a recording paper PP as an example.

### A. 1. Overview of Ink Jet Printer 1

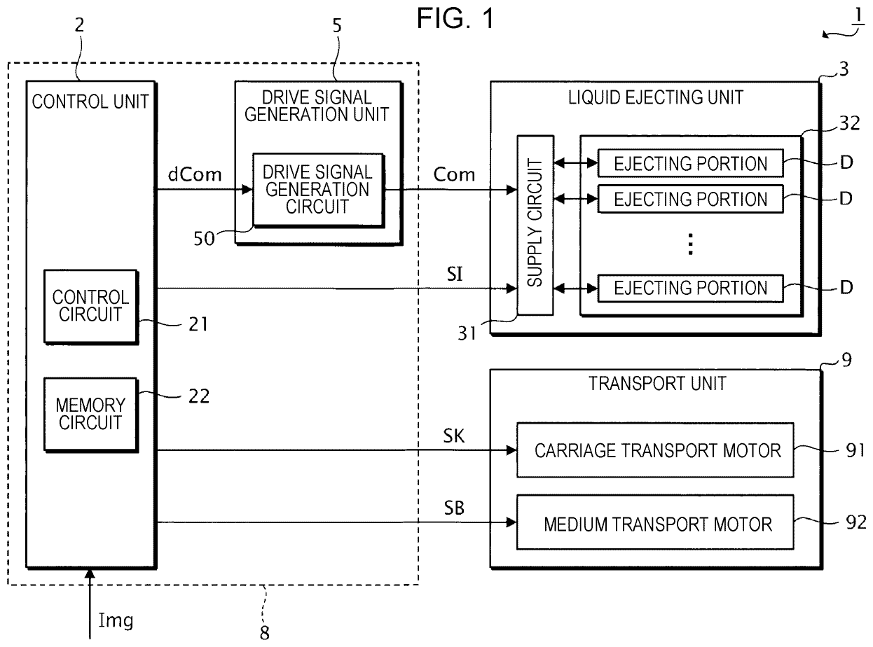

Hereinafter, an example of a configuration of an ink jet printer 1 according to the present embodiment will be described with reference to FIGS. 1 to 3.

FIG. 1 is a functional block diagram illustrating an example of a configuration of an ink jet printer 1.

As illustrated in FIG. 1, the ink jet printer 1 is supplied with print data Img indicating an image to be formed by the ink jet printer 1 from a host computer such as a personal computer or a digital camera. The ink jet printer 1 executes a printing process of forming the image, which is indicated by the print data Img supplied from the host computer, on the recording paper PP.

As illustrated in FIG. 1, the ink jet printer 1 is provided with a control unit 2 that controls each part of the ink jet printer 1, a liquid ejecting unit 3 provided with an ejecting portion D that ejects ink on the recording paper PP, a drive signal generation unit 5 provided with a drive signal generation circuit 50 that generates a drive signal Com for driving the ejecting portion D, and a transport unit 9 for transporting the liquid ejecting unit 3 and the recording paper PP.

In the present embodiment, the ink jet printer 1 is an example of a “liquid ejecting apparatus”, the liquid ejecting unit 3 is an example of a “liquid ejecting head”, the ink is an example of a “liquid”, and the recording paper PP is an example of a “medium”. In addition, in the following, the configuration including the control unit 2 and the drive signal generation unit 5 is referred to as a “drive control unit 8”. In the present embodiment, the drive control unit 8 is an example of a “drive device”.

In the present embodiment, it is assumed that the ink jet printer 1 is provided with one or a plurality of liquid ejecting units 3. Specifically, in the present embodiment, as an example, it is assumed that the ink jet printer 1 is provided with four liquid ejecting units 3. In the following, for convenience of description, as illustrated in FIG. 1, the present embodiment may be described focusing on one liquid ejecting unit 3 among the four liquid ejecting units 3.

In addition, in the present embodiment, as an example, it is assumed that the drive signal generation unit 5 is provided with one or a plurality of drive signal generation circuits 50 corresponding to one liquid ejecting unit 3. Specifically, in the present embodiment, it is assumed that the drive signal generation unit 5 is provided with two drive signal generation circuits 50 corresponding to one liquid ejecting unit 3. That is, in the present embodiment, it is assumed that the drive signal generation unit 5 is provided with eight drive signal generation circuits 50 corresponding to the four liquid ejecting units 3. Meanwhile, the present disclosure is not limited to such an aspect. The drive signal generation unit 5 may be provided with one drive signal generation circuit 50 corresponding to one liquid ejecting unit 3, or may be provided with three or more drive signal generation circuits 50 corresponding to one liquid ejecting unit 3. In the following, for convenience of description, as illustrated in FIG. 1, the present embodiment may be described focusing on one drive signal generation circuit 50 among the eight drive signal generation circuits 50.

The control unit 2 is provided with a control circuit 21 and a memory circuit 22.

Among these, the memory circuit 22 includes a volatile memory such as a random access memory (RAM) and a non-volatile memory such as a read only memory (ROM), an electrically erasable programmable read-only memory (EEPROM), or a programmable ROM (PROM), and stores various information such as a control program of the ink jet printer 1.

In addition, the control circuit 21 includes one or a plurality of central processing units (CPU). However, the control circuit 21 may be provided with a programmable logic device such as a field-programmable gate array (FPGA) instead of the CPU or in addition to the CPU. The control circuit 21 executes a control program of the ink jet printer 1 stored in the memory circuit 22 and operates in accordance with the control program to control each part of the ink jet printer 1. Specifically, the control circuit 21 generates signals for controlling the operation of each part of the ink jet printer 1, such as a designation signal SI, a waveform designation signal dCom, a carriage transport control signal SK, and a medium transport control signal SB.

Here, the waveform designation signal dCom is a digital signal for defining a waveform of the drive signal Com. The drive signal Com is an analog signal for driving the ejecting portion D. The designation signal SI is a digital signal designating the type of operation of the ejecting portion D. Specifically, the designation signal SI designates whether or not the drive signal Com is supplied to the ejecting portion D, and thus designates the type of operation of the ejecting portion D such as the presence or absence of ink ejecting from the ejecting portion D. The carriage transport control signal SK and the medium transport control signal SB are signals for controlling the transport unit 9.

In the present embodiment, the waveform designation signal dCom is an example of the “first waveform signal”.

When the printing process is executed, the control unit 2 generates a signal for controlling the liquid ejecting unit 3, such as the designation signal SI, based on the print data Img. In addition, the control unit 2 generates a signal for controlling the drive signal generation unit 5, such as the waveform designation signal dCom, when the printing process is executed. In addition, the control unit 2 generates a signal for controlling the transport unit 9 such as the carriage transport control signal SK and the medium transport control signal SB, when the printing process is executed. As a result, in the printing process, the control unit 2 controls the transport unit 9 to move the liquid ejecting unit 3 and the recording paper PP, adjusts the presence or absence of ink ejecting from the ejecting portion D, the ink ejecting timing, and the like, and controls each part of the ink jet printer 1 so that an image corresponding to the print data Img is formed on the recording paper PP.

As illustrated in FIG. 1, the liquid ejecting unit 3 is provided with a supply circuit 31 and a head portion 32.

The head portion 32 is provided with M ejecting portions D. Here, a value M is a natural number that satisfies “M≥1”. In the following, among the M ejecting portions D provided in the head portion 32, the m-th ejecting portion D may be referred to as an ejecting portion D[m]. Herein, a variable m is a natural number that satisfies “1≤m≤M”. In addition, in the following, when a component, signal, or the like of the ink jet printer 1 corresponds to the ejecting portion D[m] among the M ejecting portions D, a subscript[m] may be added to a code for representing the component, signal, or the like.

The supply circuit 31 switches whether to supply the drive signal Com to the ejecting portion D[m] based on the designation signal SI. In the following, among the drive signals Com, the drive signal Com supplied to the ejecting portion D[m] may be referred to as a supply drive signal Vin[m].

As illustrated in FIG. 1, the transport unit 9 is provided with a carriage transport motor 91 and a medium transport motor 92.

The carriage transport motor 91 transports a carriage 110 to be described later based on the carriage transport control signal SK.

The medium transport motor 92 transports the recording paper PP based on the medium transport control signal SB.

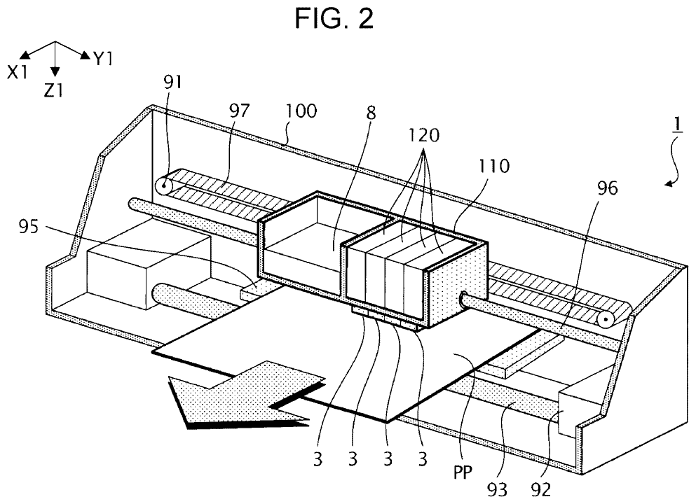

FIG. 2 is a perspective view illustrating an example of a schematic internal structure of the ink jet printer 1.

As illustrated in FIG. 2, in the present embodiment, it is assumed that the ink jet printer 1 is a serial printer. Specifically, when executing the printing process, the ink jet printer 1 ejects the ink from the liquid ejecting unit 3 while moving the liquid ejecting unit 3 in the Y1 direction intersecting the X1 direction or the Y2 direction opposite to the Y1 direction while transporting the recording paper PP in the X1 direction, and thus forms an image corresponding to the print data Img on the recording paper PP.

In the following, an X2 direction opposite to the X1 direction is collectively referred to as an “X-axis direction”, the Y2 direction opposite to the Y1 direction that intersects the X-axis direction is collectively referred to as a “Y-axis direction”, and a Z2 direction opposite to a Z1 direction that intersects the X-axis direction and the Y-axis direction is collectively referred to as a “Z-axis direction”. In the present embodiment, as an example, a description will be made by assuming that the X-axis direction, the Y-axis direction, and the Z-axis direction are orthogonal to each other. Meanwhile, the present disclosure is not limited to such an aspect. The X-axis direction, the Y-axis direction, and the Z-axis direction may intersect each other. In the present embodiment, the Z1 direction is a direction in which the ink is ejected from the ejecting portion D[m].

As illustrated in FIG. 2, the ink jet printer 1 according to the present embodiment is provided with a housing 100 and a carriage 110 that can reciprocate in the housing 100 in the Y-axis direction. The carriage 110 is mounted with four liquid ejecting units 3 and the drive control unit 8 including the control unit 2 and the drive signal generation unit 5.

As illustrated in FIG. 2, in the present embodiment, it is assumed that the carriage 110 is mounted with the four ink cartridges 120 corresponding one-to-one to four color inks of cyan, magenta, yellow, and black. In addition, in the present embodiment, as described above, it is assumed that the carriage 110 is mounted with four liquid ejecting units 3 corresponding one-to-one to the four ink cartridges 120. Each ejecting portion D[m] receives the ink supplied from the ink cartridge 120 corresponding to the liquid ejecting unit 3 provided with the ejecting portion D[m]. As a result, each ejecting portion D[m] can fill the inside with the supplied ink and eject the ink filled inside the ejecting portion D[m] from the nozzle N provided in the ejecting portion D[m]. The ink cartridge 120 may be provided outside the carriage 110.

In addition, as described above, the ink jet printer 1 according to the present embodiment is provided with the transport unit 9. As illustrated in FIG. 2, the transport unit 9 is provided with a carriage transport motor 91 for reciprocating the carriage 110 in the Y-axis direction, a carriage guide shaft 96 for supporting the carriage 110 so as to reciprocate in the Y-axis direction, a belt 97 for transporting the carriage 110 in the Y-axis direction based on the drive of the carriage transport motor 91, a medium transport motor 92 for transporting the recording paper PP in the X1 direction, a medium transport mechanism 93 for rotating based on the drive of the medium transport motor 92 to transport the recording paper PP in the X1 direction, and a platen 95 provided in the Z1 direction of the carriage 110 for supporting the recording paper PP. Therefore, when the printing process is executed, the transport unit 9 reciprocates the liquid ejecting unit 3 and the carriage 110 in the Y-axis direction along the carriage guide shaft 96 by the carriage transport motor 91, and transports the recording paper PP on the platen 95 in the X1 direction by the medium transport motor 92, so that the relative position of the recording paper PP with respect to the liquid ejecting unit 3 is changed, and the ink can land on the entire recording paper PP.

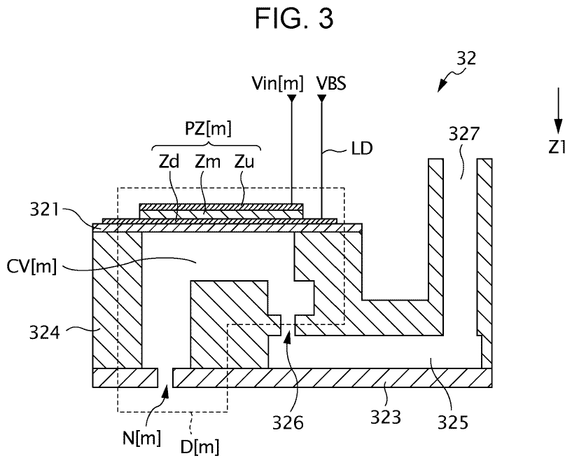

FIG. 3 is a schematic partial cross-sectional view of the head portion 32 in which the head portion 32 is cut to include the ejecting portion D[m].

As illustrated in FIG. 3, the ejecting portion D[m] is provided with the piezoelectric element PZ[m], a cavity CV[m] filled with the ink, a nozzle N[m] that communicates with the cavity CV[m], and a vibrating plate 321. The ejecting portion D[m] ejects the ink in the cavity CV[m] from the nozzle N[m] by driving the piezoelectric element PZ[m] by the supply drive signal Vin[m]. The cavity CV[m] is a space partitioned by a cavity plate 324, a nozzle plate 323 in which the nozzles N[m] are formed, and the vibrating plate 321. The cavity CV[m] communicates with a reservoir 325 via an ink supply port 326. The reservoir 325 communicates with the ink cartridge 120 corresponding to the ejecting portion D[m] via an ink intake port 327. The piezoelectric element PZ[m] includes an upper electrode Zu[m], a lower electrode Zd[m], and a piezoelectric body Zm[m] provided between the upper electrode Zu[m] and the lower electrode Zd[m]. The lower electrode Zd[m] is electrically coupled to a power supply line LD set to a predetermined potential VBS. When the supply drive signal Vin[m] is supplied to the upper electrode Zu[m] and a voltage is applied between the upper electrode Zu[m] and the lower electrode Zd[m], the piezoelectric element PZ[m] is displaced in the Z1 direction and the Z2 direction in accordance with the applied voltage. As a result, the piezoelectric element PZ[m] vibrates. The lower electrode Zd[m] is joined to the vibrating plate 321. Therefore, when the piezoelectric element PZ[m] is driven by the supply drive signal Vin[m] and vibrates, the vibrating plate 321 also vibrates. The vibration of the vibrating plate 321 changes the volume of the cavity CV[m] and the pressure in the cavity CV[m], and the ink that fills the cavity CV[m] is ejected from the nozzle N[m].

### A. 2. Configuration and Operation of Liquid Ejecting Unit 3

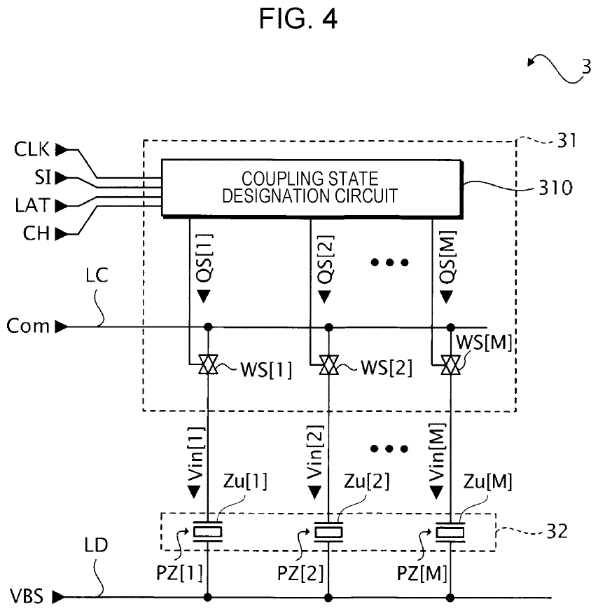

Hereinafter, an example of the configuration and operation of the liquid ejecting unit 3 will be described with reference to FIGS. 4 to 6.

FIG. 4 is a block diagram illustrating an example of a configuration of the liquid ejecting unit 3.

As illustrated in FIG. 4, the liquid ejecting unit 3 is provided with a supply circuit 31 and a head portion 32. In addition, the liquid ejecting unit 3 is provided with a wiring LC to which the drive signal Com is supplied from the drive signal generation unit 5.

As illustrated in FIG. 4, the supply circuit 31 is provided with M switches WS[1] to WS[M] that correspond one-to-one to the M ejecting portions D[1] to D[M], and a coupling state designation circuit 310 that designates the coupling state of each switch.

The coupling state designation circuit 310 generates a coupling state designation signal QS[m] that designates on or off of the switch WS[m] based on at least a part of the designation signal SI, the latch signal LAT, the change signal CH, and the clock signal CLK supplied from the control unit 2.

The switch WS[m] switches between conduction and non-conduction between the wiring LC and the upper electrode Zu[m] of the piezoelectric element PZ[m] provided on the ejecting portion D[m], based on the coupling state designation signal QS[m]. In the present embodiment, the switch WS[m] is turned on when the coupling state designation signal QS[m] is at a high level, and is turned off when the coupling state designation signal QS[m] is at a low level. When the switch WS[m] is turned on, the drive signal Com supplied to the wiring LC is supplied to the upper electrode Zu[m] of the ejecting portion D[m] as the supply drive signal Vin[m].

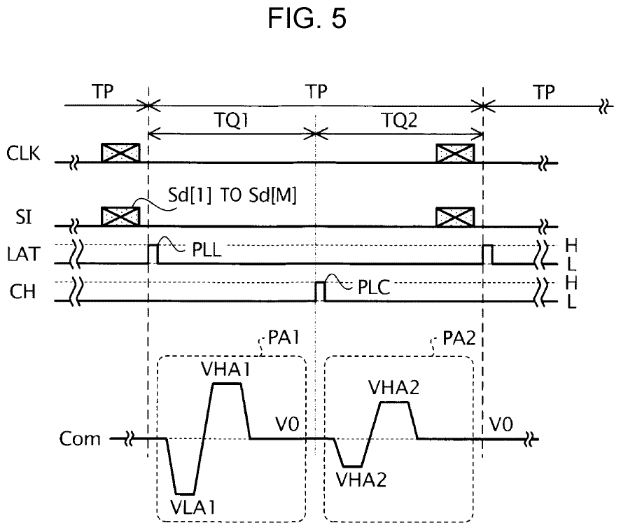

FIG. 5 is a timing chart illustrating an example of various signals such as the drive signal Com supplied to the liquid ejecting unit 3.

As illustrated in FIG. 5, when the ink jet printer 1 executes the printing process, one or a plurality of unit periods TP are set as the operation period of the ink jet printer 1. In the present embodiment, the ink jet printer 1 can drive each ejecting portion D[m] for the printing process in each unit period TP.

As illustrated in FIG. 5, the control unit 2 outputs the latch signal LAT having a pulse PLL. Accordingly, the control unit 2 defines the unit period TP as a period from the rise of the pulse PLL to the rise of the next pulse PLL. In addition, the control unit 2 outputs the change signal CH having a pulse PLC in the unit period TP. The control unit 2 divides the unit period TP into a drive period TQ1 from the rise of the pulse PLL to the rise of the pulse PLC and a drive period TQ2 from the rise of the pulse PLC to the rise of the pulse PLL.

As illustrated in FIG. 5, the designation signal SI includes M individual designation signals Sd[1] to Sd[M] corresponding one-to-one to the M ejecting portions D[1] to D[M]. The individual designation signal Sd[m] designates the aspect of driving the ejecting portion D[m] in each unit period TP when the ink jet printer 1 executes the printing process. The control unit 2 supplies the designation signal SI including the M individual designation signals Sd[1] to Sd[M] to the coupling state designation circuit 310 in synchronization with the clock signal CLK prior to each unit period TP. The coupling state designation circuit 310 generates the coupling state designation signal QS[m] based on the individual designation signal Sd[m] in the unit period TP.

In the present embodiment, it is assumed that the ejecting portion D[m] can form any one of a large dot formed of the ink having the ink amount ξ1, a medium dot formed of the ink having the ink amount ξ2 smaller than the ink amount ξ1, and a small dot formed of the ink having the ink amount ξ3 smaller than the ink amount ξ2, in the unit period TP in which the printing process is executed.

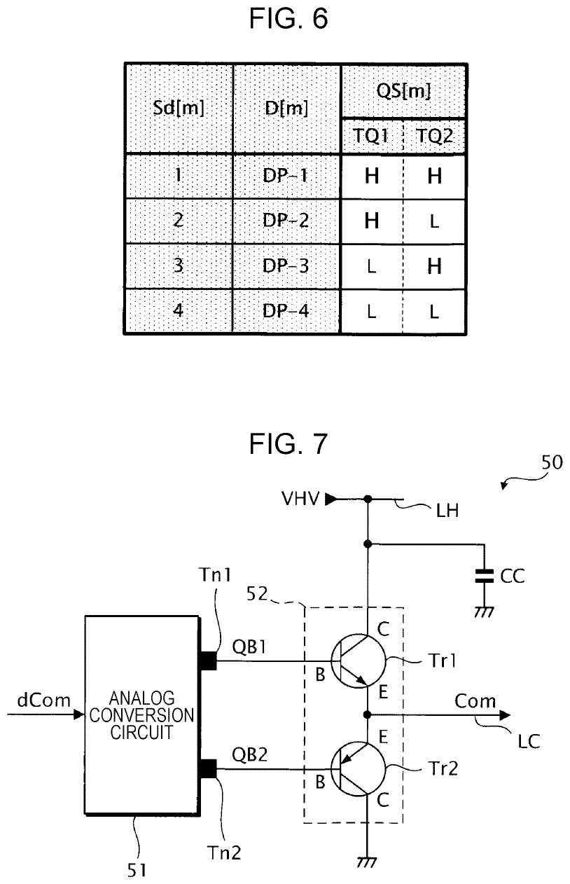

FIG. 6 is an explanatory diagram illustrating an example of an individual designation signal Sd[m].

As illustrated in FIG. 6, in the present embodiment, the individual designation signal Sd[m] can take any one value among four values, a value of “1” that designates the ejecting portion D[m] as a large dot forming ejecting portion DP-1, a value of “2” that designates the ejecting portion D[m] as a medium dot forming ejecting portion DP-2, a value of “3” that designates the ejecting portion D[m] as a small dot forming ejecting portion DP-3, and a value of “4” that designates the ejecting portion D[m] as a dot non-forming ejecting portion DP-4, in the unit period TP in which the printing process is executed.

Here, the large dot forming ejecting portion DP-1 is an ejecting portion D that forms the large dot in the unit period TP. In addition, the medium dot forming ejecting portion DP-2 is an ejecting portion D that forms the medium dot in the unit period TP. In addition, the small dot forming ejecting portion DP-3 is an ejecting portion D that forms the small dot in the unit period TP. In addition, the dot non-forming ejecting portion DP-4 is an ejecting portion D that does not form the dot in the unit period TP.

The description is returned to FIG. 5.

As illustrated in FIG. 5, in the present embodiment, the drive signal Com has a waveform PA1 provided in the drive period TQ1 and a waveform PA2 provided in the drive period TQ2.

Among these, the waveform PA1 is a waveform that returns to the potential V0 from the potential V0 via a potential VLA1 lower than the potential V0 and a potential VHA1 higher than the potential V0. When the supply drive signal Vin[m] having the waveform PA1 is supplied to the ejecting portion D[m], the waveform PA1 is determined such that the ink corresponding to an ink amount φ1 is ejected from the ejecting portion D[m]. In addition, the waveform PA2 is a waveform that returns to the potential V0 from the potential V0 via a potential VLA2 lower than the potential V0 and a potential VHA2 higher than the potential V0. When the supply drive signal Vin[m] having the waveform PA2 is supplied to the ejecting portion D[m], the waveform PA2 is determined such that the ink corresponding to an ink amount φ2 is ejected from the ejecting portion D[m]. In the present embodiment, it is assumed that the ink amount ξ1 corresponds to the total amount of the ink amount φ1 and the ink amount φ2, the ink amount ξ2 corresponds to the ink amount φ1, and the ink amount ξ3 corresponds to the ink amount φ2.

In addition, in the present embodiment, as an example, it is assumed that when the potential of the supply drive signal Vin[m] supplied to the ejecting portion D[m] is high, the volume of the cavity CV[m] provided in the ejecting portion D[m] is small as compared with a case of low potential. Therefore, when the ejecting portion D[m] is driven by the supply drive signal Vin[m] having the waveform PA1 or the like, the potential of the supply drive signal Vin[m] changes from a low potential to a high potential, and thus the ink in the ejecting portion D[m] is ejected from the nozzle N[m].

As illustrated in FIG. 6, when the individual designation signal Sd[m] indicates the value “1” that designates the ejecting portion D[m] as the large dot forming ejecting portion DP-1 in the unit period TP, the coupling state designation circuit 310 sets the coupling state designation signal QS[m] to a high level in the drive period TQ1 and the drive period TQ2. In this case, the switch WS[m] is turned on in the drive period TQ1 and the drive period TQ2. Therefore, the ejecting portion D[m] is driven by the supply drive signal Vin[m] having the waveform PA1 and the waveform PA2 in the unit period TP, and ejects the ink having an ink amount ξ1 corresponding to a large dot.

In addition, when the individual designation signal Sd[m] indicates the value “2” that designates the ejecting portion D[m] as the medium dot forming ejecting portion DP-2 in the unit period TP, the coupling state designation circuit 310 sets the coupling state designation signal QS[m] to a high level in the drive period TQ1. In this case, the switch WS[m] is turned on in the drive period TQ1. Therefore, the ejecting portion D[m] is driven by the supply drive signal Vin[m] having the waveform PA1 in the unit period TP, and ejects the ink having the ink amount ξ2 corresponding to the medium dot.

In addition, when the individual designation signal Sd[m] indicates the value “3” that designates the ejecting portion D[m] as the small dot forming ejecting portion DP-3 in the unit period TP, the coupling state designation circuit 310 sets the coupling state designation signal QS[m] to a high level in the drive period TQ2. In this case, the switch WS[m] is turned on in the drive period TQ2. Therefore, the ejecting portion D[m] is driven by the supply drive signal Vin[m] having the waveform PA2 in the unit period TP, and ejects the ink having the ink amount ξ3 corresponding to the small dot.

In addition, when the individual designation signal Sd[m] indicates the value “4” that designates the ejecting portion D[m] as the dot non-forming ejecting portion DP-4 in the unit period TP, the coupling state designation circuit 310 sets the coupling state designation signal QS[m] to a low level over the unit period TP. In this case, the switch WS[m] is turned off over the unit period TP. Therefore, the ejecting portion D[m] is not driven by the supply drive signal Vin[m] and does not eject the ink in the unit period TP.

### A. 3. Configuration of Drive Signal Generation Circuit 50

Hereinafter, an example of the configuration of the drive signal generation circuit 50 provided in the drive signal generation unit 5 will be described with reference to FIG. 7.

FIG. 7 is a block diagram illustrating an example of a circuit configuration of the drive signal generation circuit 50.

As illustrated in FIG. 7, the drive signal generation circuit 50 is provided with an analog conversion circuit 51, a transistor pair 52, and an electrolytic capacitor CC, and generates an analog drive signal Com having a waveform designated by the waveform designation signal dCom based on the digital waveform designation signal dCom. Specifically, the drive signal generation circuit 50 generates the drive signal Com by, for example, performing AB class amplification on an input signal obtained by performing analog conversion on the waveform designation signal dCom.

The analog conversion circuit 51 outputs the waveform designation signal QB including the base supply signal QB1 and the base supply signal QB2 based on the digital waveform designation signal dCom. Specifically, the analog conversion circuit 51 converts the waveform designation signal dCom into an analog input signal, and then generates a base supply signal QB1, which is an analog signal indicating a potential based on a potential of the input signal, and a base supply signal QB2, which is an analog signal indicating a potential based on a potential of the input signal and a potential lower than the potential of the base supply signal QB1. The analog conversion circuit 51 outputs the base supply signal QB1 from an output terminal Tn1 and outputs the base supply signal QB2 from an output terminal Tn2.

In the present embodiment, the waveform designation signal QB is an example of the “second waveform signal”.

The transistor pair 52 is a so-called push-pull circuit including an NPN-type bipolar transistor Tr1 and a PNP-type bipolar transistor Tr2, and generates the drive signal Com based on the base supply signal QB1 and the base supply signal QB2.

In the bipolar transistor Tr1, the base electrode (B) is electrically coupled to the output terminal Tn1, and the base supply signal QB1 is supplied from the output terminal Tn1. In addition, in the bipolar transistor Tr1, the collector electrode (C) is electrically coupled to a power supply line LH in which the power supply potential VHV is set, and the emitter electrode (E) is electrically coupled to the wiring LC for supplying the drive signal Com. The bipolar transistor Tr1 is turned on when the potential of the base supply signal QB1 rises, for example, and as a result, the potential of the drive signal Com rises. In addition, for example, the bipolar transistor Tr1 is turned off when the potential of the base supply signal QB1 is constant and the potential of the base supply signal QB1 decreases.

In the bipolar transistor Tr2, the base electrode (B) is electrically coupled to the output terminal Tn2, and the base supply signal QB2 is supplied from the output terminal Tn2. In addition, in the bipolar transistor Tr2, the collector electrode (C) is electrically coupled to the ground, and the emitter electrode (E) is electrically coupled to the wiring LC for supplying the drive signal Com. The bipolar transistor Tr2 is turned on when the potential of the base supply signal QB2 decreases, and as a result, the potential of the drive signal Com decreases. In addition, the bipolar transistor Tr2 is turned off when the potential of the base supply signal QB2 is constant and the potential of the base supply signal QB2 rises.

The electrolytic capacitor CC is a capacitor for supplying a current to the transistor pair 52. Specifically, in the electrolytic capacitor CC, one electrode of the two electrodes of the electrolytic capacitor CC is electrically coupled to the power supply line LH and the collector electrode of the bipolar transistor Tr1, and the other electrode is electrically coupled to the ground.

### A. 4. Configuration of Drive Control Unit 8

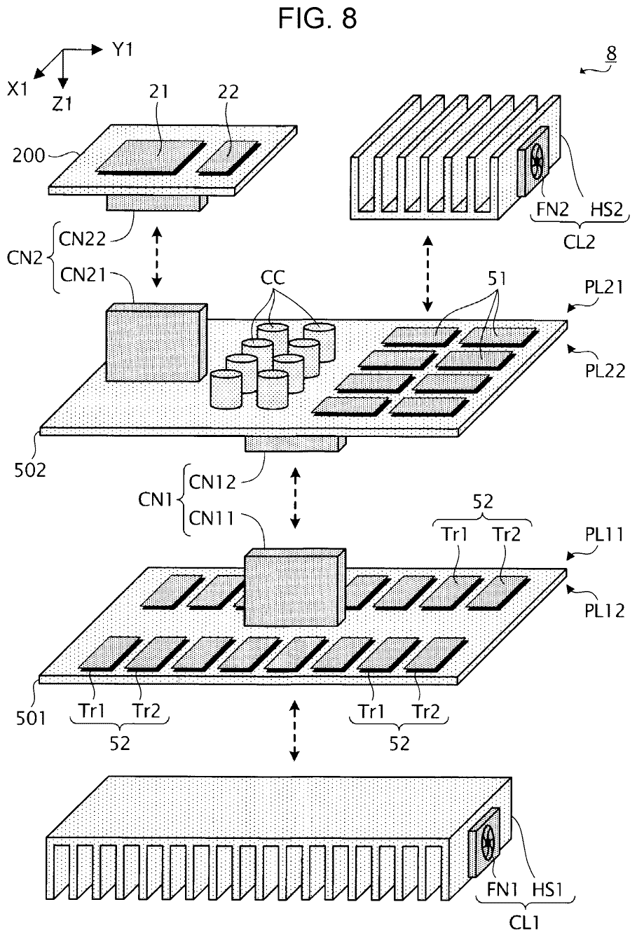

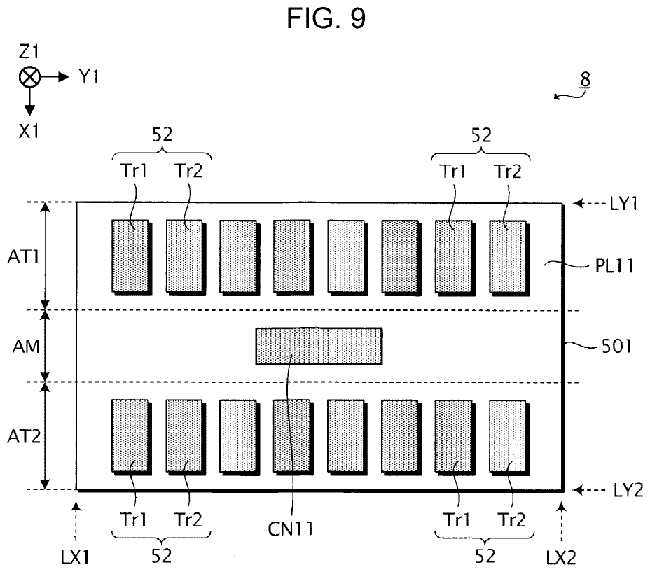

Hereinafter, an example of a configuration of the drive control unit 8 will be described with reference to FIGS. 8 to 11.

FIG. 8 is an exploded perspective view illustrating an example of the configuration of the drive control unit 8.

As illustrated in FIG. 8, the drive control unit 8 is provided with a control substrate 200, a transistor substrate 501, an analog conversion circuit substrate 502, a transistor cooling mechanism CL1, and an analog conversion circuit cooling mechanism CL2. In the present embodiment, as an example, it is assumed that the control substrate 200, the transistor substrate 501, and the analog conversion circuit substrate 502 are provided to extend on a plane in which the Z1 direction is a normal direction.

In the present embodiment, the transistor substrate 501 is an example of a “first substrate”, the analog conversion circuit substrate 502 is an example of a “second substrate”, and the control substrate 200 is an example of a “third substrate”.

The control circuit 21 and the memory circuit 22 are provided on the control substrate 200. The control unit 2 described above includes a control substrate 200, a control circuit 21, and a memory circuit 22.

On the transistor substrate 501, the transistor pair 52 including the bipolar transistor Tr1 and the bipolar transistor Tr2 is provided in the drive signal generation circuit 50. Specifically, in the present embodiment, it is assumed that the transistor pair 52 is provided on the surface PL11 in which the Z2 direction is a normal direction, among the plurality of surfaces included in the transistor substrate 501. As described above, in the present embodiment, it is assumed that the drive signal generation circuit 50 is provided with eight drive signal generation circuits 50. Therefore, in the present embodiment, eight bipolar transistors Tr1 and eight bipolar transistors Tr2 included in the eight transistor pairs 52 are provided on the surface PL11 of the transistor substrate 501. In the following, the bipolar transistor Tr1 and the bipolar transistor Tr2 may be collectively referred to as the bipolar transistor Tr.

The analog conversion circuit 51 and the electrolytic capacitor CC of the drive signal generation circuit 50 are provided on the analog conversion circuit substrate 502. Specifically, in the present embodiment, it is assumed that the analog conversion circuit 51 and the electrolytic capacitor CC are provided on the surface PL21 in which the Z2 direction is a normal direction, among the plurality of surfaces included in the analog conversion circuit substrate 502. As described above, in the present embodiment, it is assumed that the drive signal generation circuit 50 is provided with eight drive signal generation circuits 50. Therefore, in the present embodiment, eight analog conversion circuits 51 and eight electrolytic capacitors CC are provided on the analog conversion circuit substrate 502.

The transistor cooling mechanism CL1 is provided with a heat sink HS1 and a fan FN1. In the present embodiment, the transistor cooling mechanism CL1 is an example of the “first cooling mechanism”.

The heat sink HS1 is coupled to the transistor substrate 501 and dissipates heat generated in the transistor pair 52 provided on the transistor substrate 501. In the present embodiment, it is assumed that the heat sink HS1 is coupled to a surface PL12 in which the Z1 direction is a normal direction, among the plurality of surfaces included in the transistor substrate 501.

Although details will be described later, in the present embodiment, the transistor substrate 501 has an aluminum base material 75. In addition, in the present embodiment, the heat sink HS1 is formed of aluminum.

The fan FN1 is coupled to the heat sink HS1 and cools the heat sink HS1. However, the fan FN1 may be coupled to the transistor substrate 501 and may cool the transistor substrate 501. In the present embodiment, it is assumed that the fan FN1 maintains the operating state during the period in which the ink jet printer 1 executes the printing process and the drive signal generation circuit 50 generates the drive signal Com. For example, in the present embodiment, when the control unit 2 supplies the waveform designation signal dCom to the drive signal generation circuit 50, the fan FN1 may maintain the operating state.

The analog conversion circuit cooling mechanism CL2 is provided with a heat sink HS2 and a fan FN2. In the present embodiment, the analog conversion circuit cooling mechanism CL2 is an example of a “second cooling mechanism”.

The heat sink HS2 is coupled to the analog conversion circuit substrate 502 and dissipates heat generated in the analog conversion circuit 51 provided on the analog conversion circuit substrate 502. In the present embodiment, it is assumed that the heat sink HS2 is coupled to the surface PL21 among the plurality of surfaces included in the analog conversion circuit substrate 502. However, the heat sink HS2 may be provided to be directly coupled to the analog conversion circuit 51 provided on the surface PL21 of the analog conversion circuit substrate 502.

Although details will be described later, in the present embodiment, the analog conversion circuit substrate 502 has an aluminum base material. In addition, in the present embodiment, the heat sink HS2 is formed of aluminum.

The fan FN2 is coupled to the heat sink HS2 and cools the heat sink HS2. However, the fan FN2 may be coupled to the analog conversion circuit substrate 502 to cool the analog conversion circuit substrate 502. In addition, the fan FN2 may be coupled to the analog conversion circuit 51 and may cool the analog conversion circuit 51. In the present embodiment, it is assumed that the fan EN2 maintains the operating state during the period in which the ink jet printer 1 executes the printing process and the drive signal generation circuit 50 generates the drive signal Com. For example, in the present embodiment, when the control unit 2 supplies the waveform designation signal dCom to the drive signal generation circuit 50, the fan FN2 may maintain the operating state.

The transistor substrate 501 and the analog conversion circuit substrate 502 are coupled by a substrate-to-substrate connector CN1. Specifically, the substrate-to-substrate connector CN1 is provided with a receptacle CN11 fixed to the surface PL11 of the transistor substrate 501, and a plug CN12 fixed to the surface PL22, in which the Z1 direction is a normal direction, among the plurality of surfaces included in the analog conversion circuit substrate 502 and configured to be fitted with the receptacle CN11. The substrate-to-substrate connector CN1 fixes the transistor substrate 501 and the analog conversion circuit substrate 502 by fitting the receptacle CN11 and the plug CN12, and transmits a signal between the transistor substrate 501 and the analog conversion circuit substrate 502.

The analog conversion circuit substrate 502 and the control substrate 200 are coupled by a substrate-to-substrate connector CN2. Specifically, the substrate-to-substrate connector CN2 is provided with a receptacle CN21 fixed to the surface PL21 of the analog conversion circuit substrate 502, and a plug CN22 fixed to a surface, in which the Z1 direction is a normal direction, among the plurality of surfaces included in the control substrate 200 and configured to be fitted with the receptacle CN21. The substrate-to-substrate connector CN2 fixes the analog conversion circuit substrate 502 and the control substrate 200 by fitting the receptacle CN21 and the plug CN22, and transmits a signal between the analog conversion circuit substrate 502 and the control substrate 200.

FIG. 9 is a plan view illustrating an example of the disposition of various electronic components on the transistor substrate 501 when the transistor substrate 501 is viewed in a plan view in the Z1 direction.

As illustrated in FIG. 9, the transistor substrate 501 is provided with a long side LY1 extending in the Y1 direction and positioned at an end portion in the X2 direction of the transistor substrate 501, a long side LY2 extending in the Y1 direction so as to face the long side LY1 and positioned at an end portion in the X1 direction of the transistor substrate 501, a short side LX1 extending in the X1 direction and positioned at an end portion in the Y2 direction of the transistor substrate 501, and a short side LX2 extending in the X1 direction so as to face the short side LX1 and positioned at an end portion in the Y1 direction of the transistor substrate 501. In the present embodiment, the long side LY1 and the long side LY2 have substantially the same length, the short side LX1 and the short side LX2 have substantially the same length, and the long side LY1 is longer than the short side LX1. Here, the term of “substantially the same” includes when the two are considered to be the same when an error is taken into consideration, in addition to a case where the two are completely the same. For example, the term of “substantially the same” may be the same in design. In addition, the term of “substantially the same” may be a concept that includes when the two are considered to be the same when an error of approximately 5% is taken into consideration.

The surface PL11 included in the transistor substrate 501 is divided into an end portion region AT1 including the long side LY1, an end portion region AT2 including the long side LY2, and a central region AM disposed between the end portion region AT1 and the end portion region AT2 when the transistor substrate 501 is viewed in plan view in the Z1 direction.

As illustrated in FIG. 9, in the present embodiment, it is assumed that 16 bipolar transistors Tr included in the drive signal generation circuit 50 are provided in the end portion region AT1 or the end portion region AT2. Specifically, in the present embodiment, it is assumed that eight bipolar transistors Tr among the 16 bipolar transistors Tr included in the drive signal generation circuit 50 are provided in the end portion region AT1, and eight bipolar transistors Tr among the 16 bipolar transistors Tr included in the drive signal generation circuit 50 are provided in the end portion region AT2. That is, in the present embodiment, it is assumed that the 16 bipolar transistors Tr included in the drive signal generation circuit 50 are disposed along the long side LY1 or the long side LY2. Therefore, according to the present embodiment, heat generated from the bipolar transistor Tr can be efficiently dissipated from the long side LY1 or the long side LY2, as compared with the case where the bipolar transistor Tr is provided in the central region AM.

In addition, as illustrated in FIG. 9, in the present embodiment, an aspect is assumed in which the substrate-to-substrate connector CN1 is provided in the central region AM. Therefore, according to the present embodiment, the change in the relative position and the change in the relative posture between the transistor substrate 501 and the analog conversion circuit substrate 502 can be reduced, as compared with an aspect where the substrate-to-substrate connector CN1 is provided in the end portion region AT1 or the end portion region AT2, and the transistor substrate 501 and the analog conversion circuit substrate 502 can be stably coupled by the substrate-to-substrate connector CN1.

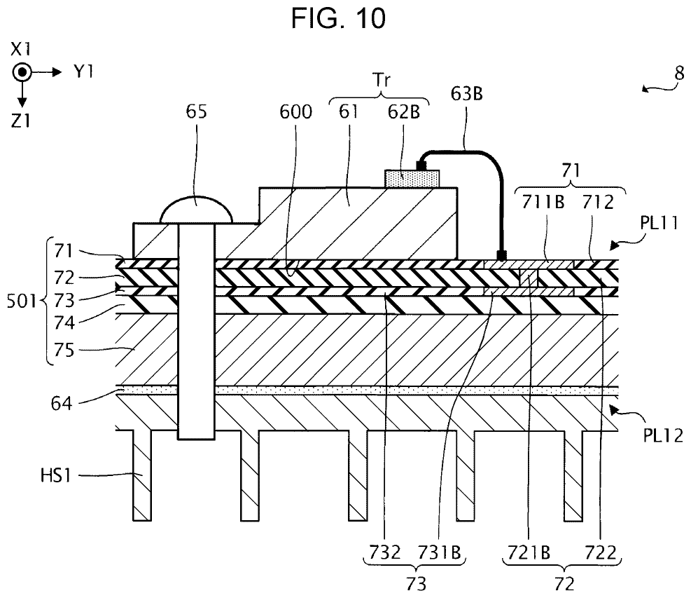

FIG. 10 is a cross-sectional view illustrating an example of a cross-sectional configuration of the transistor substrate 501, the bipolar transistor Tr, and the heat sink HS1.

As illustrated in FIG. 10, the bipolar transistor Tr is provided with a chip main body portion 61, a base electrode 62B, a collector electrode 62C, and an emitter electrode 62E. In FIG. 10, the collector electrode 62C and the emitter electrode 62E are not illustrated, but the collector electrode 62C is, for example, present in the X1 direction from the base electrode 62B, and the emitter electrode 62E is, for example, present in the X2 direction from the base electrode 62B.

As illustrated in FIG. 10, the transistor substrate 501 is provided with a wiring layer 71, an insulation layer 72, a wiring layer 73, an insulation layer 74, and a base material 75.

The wiring layer 71 is provided with an insulating resist 712, a wiring 711B electrically coupled to the base electrode 62B via a wiring 63B, a wiring 711C electrically coupled to the collector electrode 62C via a wiring 63C (not illustrated), and a wiring 711E electrically coupled to the emitter electrode 62E via a wiring 63E (not illustrated). In FIG. 10, the wiring 711C and the wiring 711E are not illustrated, but the wiring 711C is disposed, for example, in a state of being insulated from the wiring 711B in the X1 direction from the wiring 711B, and the wiring 711E is disposed, for example, in a state of being insulated from the wiring 711B in the X2 direction from the wiring 711B. Of the surfaces of the wiring layer 71, the surface facing the Z2 direction corresponds to the surface PL11.

The insulation layer 72 is provided with an insulation portion 722 formed of an insulating material, a coupling wiring 721B electrically coupled to the wiring 711B, a coupling wiring 721C electrically coupled to the wiring 711C, and a coupling wiring 721E electrically coupled to the wiring 711E. In FIG. 10, the coupling wiring 721C and the coupling wiring 721E are not illustrated, but the coupling wiring 721C is disposed, for example, in a state of being insulated from the coupling wiring 721B in the X1 direction from the coupling wiring 721B, and the coupling wiring 721E is disposed, for example, in a state of being insulated from the coupling wiring 721B in the X2 direction from the coupling wiring 721B.

The wiring layer 73 is provided with an insulation portion 732 formed of an insulating material, a wiring 731B electrically coupled to the coupling wiring 721B, a wiring 731C electrically coupled to the coupling wiring 721C, and a wiring 731E electrically coupled to the coupling wiring 721E. In FIG. 10, the wiring 731C and the wiring 731E are not illustrated, but the wiring 731C is disposed, for example, in a state of being insulated from the wiring 731B in the X1 direction from the wiring 731B, and the wiring 731E is disposed, for example, in a state of being insulated from the wiring 731B in the X2 direction from the wiring 731B.

The insulation layer 74 electrically insulates the wiring 731B, the wiring 731C, and the wiring 731E provided in the wiring layer 73 from the base material 75.

The base material 75 is formed of aluminum. In the present embodiment, it is assumed that the heat sink HS1 is coupled to the base material 75 by the grease 64. However, the heat sink HS1 may be coupled to the base material 75 by the heat dissipation sheet. Of the surfaces of the base material 75, the surface facing the Z1 direction corresponds to the surface PL12.

As illustrated in FIG. 10, in the bipolar transistor Tr, the surface 600 having the largest area among the surfaces included in the bipolar transistor Tr is provided to be coupled to the surface PL11 included in the wiring layer 71 of the transistor substrate 501.

In addition, the bipolar transistor Tr is fixed to the transistor substrate 501 by the screw 65. Specifically, in the present embodiment, the bipolar transistor Tr is fixed to the transistor substrate 501 and the heat sink HS1 by the screw 65 penetrating the transistor substrate 501. In the present embodiment, it is assumed that the screw 65 is made of metal. The screw 65 may be a non-metal. However, it is preferable that the screw 65 is formed of a material having higher thermal conductivity than the resistor 712, the insulation portion 722, the insulation portion 732, and the insulation layer 74 in the transistor substrate 501.

As described above, in the present embodiment, the base material 75 included in the transistor substrate 501 is formed of aluminum. In addition, in the present embodiment, the heat sink HS1 is formed of aluminum.

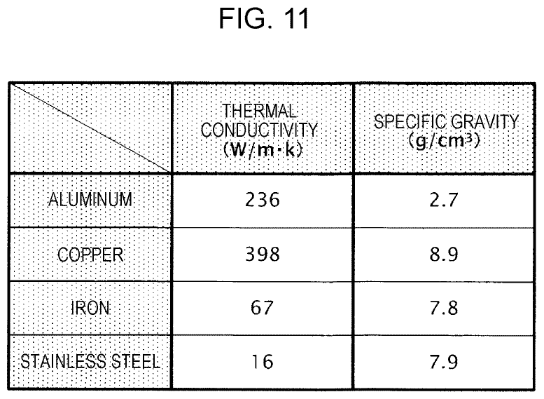

FIG. 11 is a table illustrating the thermal conductivities and specific gravities of various metals.

As illustrated in FIG. 11, the thermal conductivity of copper is 398 W/mk. Therefore, the thermal conductivity of copper is high as compared with aluminum having a thermal conductivity of 236 W/mk, iron having a thermal conductivity of 67 W/mk, and stainless steel having a thermal conductivity of 16 W/mk. That is, a copper substrate having a copper base material as the transistor substrate 501 is adopted and a copper substrate having a copper base material as the analog conversion circuit substrate 502 is adopted, and thus the heat generated in the drive signal generation unit 5 can be efficiently dissipated. In addition, as a material having a higher thermal conductivity than copper, silver having a thermal conductivity of 398 W/mk and diamond having a thermal conductivity of 1000 W/mk are also present. However, these materials are expensive, and thus it is not practical to adopt these materials as the substrate of the drive signal generation unit 5. Therefore, in the related art, it is common to adopt a copper substrate as a substrate of the drive signal generation unit 5.

On the other hand, as illustrated in FIG. 11, the specific gravity of aluminum is 2.7 g/cm³. Therefore, the specific gravity of aluminum is smaller than the specific gravity of copper of 8.9 g/cm³, the specific gravity of iron of 7.8 g/cm³, and the specific gravity of stainless steel of 7.9 g/cm³. Therefore, in the drive signal generation unit 5 according to the present embodiment, the weight of the drive signal generation unit 5 can be reduced as compared with the drive signal generation unit adopting the copper substrate in the related art. As a result, the drive signal generation unit 5 according to the present embodiment can reduce the load on the carriage transport motor 91 that drives the carriage 110 when the drive signal generation unit 5 is mounted on the carriage 110 and the drive signal generation unit 5 is moved. That is, in the drive signal generation unit 5 according to the present embodiment, the life of the carriage transport motor 91 can be increased and the amount of power required for driving the carriage transport motor 91 can be reduced, as compared with the drive signal generation unit adopting the copper substrate in the related art.

In addition, as described above, the thermal conductivity of aluminum is lower than the thermal conductivity of copper, but is higher than the thermal conductivity of iron and stainless steel. Therefore, according to the drive signal generation unit 5 according to the present embodiment, both the reduction of the load on the carriage transport motor 91 that drives the carriage 110 and efficient heat dissipation in the drive signal generation unit 5 can be achieved.

In addition, it is common that a heat sink is attached to the drive signal generation unit 5 having a large amount of heat generation, and the heat dissipation of the drive signal generation unit 5 is improved. The heat sink is generally formed of aluminum. Therefore, when the heat sink formed of aluminum is attached to the drive signal generation unit adopting the copper substrate as in the related art, there is a high possibility that corrosion occurs at the boundary between the copper substrate and an aluminum heat sink. Therefore, in the drive signal generation unit adopting the copper substrate as in the related art, when the aluminum heat sink is attached, it is common to interpose a heat dissipation sheet between the copper substrate and the heat sink made of aluminum in order to prevent corrosion at the boundary between the copper substrate and the aluminum heat sink. Therefore, in the drive signal generation unit adopting the copper substrate as in the related art, there is a problem in that the drive signal generation unit is increased in size, the cost of the drive signal generation unit is increased, the number of components of the drive signal generation unit is increased, and the like.

On the other hand, the drive signal generation unit 5 according to the present embodiment adopts an aluminum substrate in which the base material 75 is formed of aluminum as the transistor substrate 501. Therefore, in the drive signal generation unit 5 according to the present embodiment, corrosion at the boundary between the base material 75 formed of aluminum and the heat sink HS1 formed of aluminum is not a problem. Therefore, in the drive signal generation unit 5 according to the present embodiment, it is not necessary to interpose the heat dissipation sheet between the transistor substrate 501 and the heat sink HS1, and it is only necessary to interpose the grease 64 between the transistor substrate 501 and the heat sink HS1. As a result, in the drive signal generation unit 5 according to the present embodiment, the size of the drive signal generation unit 5 can be reduced, the cost of the drive signal generation unit 5 can be reduced, and the number of components of the drive signal generation unit 5 can be reduced, as compared with the drive signal generation unit adopting the copper substrate in the related art.

As a base metal, aluminum is second only to iron in production volume, and is said to exceed even iron in terms of the ratio of reserves to current demand. In addition, aluminum is a metal that is excellent in recyclability as compared with copper. On the other hand, the amount of copper resources is limited, and it is expected that the amount of copper used will be equal to or greater than the current amount of reserves by 2050. On the other hand, in the present embodiment, the drive signal generation unit 5 adopts an aluminum substrate having the base material 75 formed of aluminum. Therefore, according to the present embodiment, the environmental load can be reduced, as compared with an aspect where the copper substrate is adopted for the drive signal generation unit 5, and the influence on the future “copper shortage” can be reduced.

### A. 5. Summary of Embodiment

As described above, according to the present embodiment, since the aluminum substrate having an aluminum base material is adopted as the transistor substrate 501 and the analog conversion circuit substrate 502, the weight of the drive signal generation unit 5 can be reduced, as compared with the drive signal generation unit adopting the copper substrate as in the related art. As a result, according to the present embodiment, when the drive signal generation unit 5 is mounted on the carriage 110 and the drive signal generation unit 5 is moved, the load on the carriage transport motor 91 that drives the carriage 110 can be reduced. That is, in the drive signal generation unit 5 according to the present embodiment, the life of the carriage transport motor 91 can be increased and the amount of power required for driving the carriage transport motor 91 can be reduced, as compared with the drive signal generation unit adopting the copper substrate in the related art.

In addition, in the drive signal generation unit 5 according to the present embodiment, the aluminum substrate in which the base material 75 is formed of aluminum is adopted as the transistor substrate 501. Therefore, in the drive signal generation unit 5 according to the present embodiment, corrosion at the boundary between the base material 75 formed of aluminum and the heat sink HS1 formed of aluminum is not a problem. Therefore, in the drive signal generation unit 5 according to the present embodiment, it is not necessary to interpose the heat dissipation sheet between the transistor substrate 501 and the heat sink HS1. Similarly, in the drive signal generation unit 5 according to the present embodiment, it is not necessary to interpose a heat dissipation sheet between the analog conversion circuit substrate 502 and the heat sink HS2. Therefore, according to the drive signal generation unit 5 according to the present embodiment, the size of the drive signal generation unit 5 can be reduced, the cost of the drive signal generation unit 5 can be reduced, and the number of components of the drive signal generation unit 5 can be reduced, as compared with the drive signal generation unit adopting the copper substrate in the related art.

In addition, in the drive signal generation unit 5 according to the present embodiment, the analog conversion circuit substrate 502 provided with the analog conversion circuit 51 is a separate substrate from the transistor substrate 501 provided with the transistor pair 52. Therefore, in the drive signal generation unit 5 according to the present embodiment, the transfer of heat generated in the transistor pair 52 to the analog conversion circuit 51 can be prevented, and the overheating of the analog conversion circuit 51 can be prevented, as compared with an aspect where the transistor pair 52 and the analog conversion circuit 51 are provided on the same substrate.

In addition, in the drive signal generation unit 5 according to the present embodiment, the control substrate 200 provided with the control circuit 21 is a separate substrate from the transistor substrate 501 provided with the transistor pair 52. Therefore, in the drive signal generation unit 5 according to the present embodiment, the transfer of heat generated in the transistor pair 52 to the control circuit 21 can be prevented, and the overheating of the control circuit 21 can be prevented, as compared with an aspect where the transistor pair 52 and the control circuit 21 are provided on the same substrate.

In addition, in the drive signal generation unit 5 according to the present embodiment, the analog conversion circuit cooling mechanism CL2 for cooling the analog conversion circuit substrate 502 provided with the analog conversion circuit 51 is provided separately from the transistor cooling mechanism CL1 for cooling the transistor substrate 501 provided with the transistor pair 52. Therefore, the drive signal generation unit 5 according to the present embodiment can efficiently cool the analog conversion circuit substrate 502, as compared with an aspect where the cooling of the analog conversion circuit substrate 502 is shared with the transistor cooling mechanism CL1 that cools the transistor substrate 501. Therefore, the drive signal generation unit 5 according to the present embodiment can effectively prevent the heat generation in the analog conversion circuit 51 even when the drive signal Com is a signal having a large amplitude and the base current supplied from the analog conversion circuit 51 to the transistor pair 52 is a large current.

In addition, in the drive signal generation unit 5 according to the present embodiment, the transistor substrate 501 and the analog conversion circuit substrate 502 are fixed to each other by the substrate-to-substrate connector CN1. Therefore, according to the present embodiment, even when the drive signal generation unit 5 is mounted on the carriage 110 and moves inside the ink jet printer 1, as compared with an aspect where the transistor substrate 501 and the analog conversion circuit substrate 502 are coupled to each other by, for example, a flexible printed substrate or the like, the occurrence of a relative positional displacement between the transistor substrate 501 and the analog conversion circuit substrate 502 and the occurrence of a relative posture displacement between the transistor substrate 501 and the analog conversion circuit substrate 502 can be prevented. As a result, according to the present embodiment, the transistor substrate 501 and the analog conversion circuit substrate 502 can be stably coupled. Similarly, according to the present embodiment, the analog conversion circuit substrate 502 and the control substrate 200 can be stably coupled.

### B. Modification Example

Each embodiment above can be modified in various manners. A specific aspect of the modification is illustrated below. Two or more aspects selected in any manner from the following examples can be appropriately combined with one another within a range not inconsistent with one another. In modification examples to be described below, elements having the same effects and functions as those of the embodiment will be given the reference numerals used in the above description, and each detailed description thereof will be appropriately omitted.

### B. 1. Modification Example 1

In the above-described embodiment, a case where the analog conversion circuit substrate 502 is an aluminum substrate in which the base material is formed of aluminum is described as an example, but the present disclosure is not limited to such an aspect. The analog conversion circuit substrate 502 may be a copper substrate in which a base material is formed of copper. The analog conversion circuit substrate 502 may be a metal substrate in which a base material is formed of a metal.

In addition, in the above-described embodiment, a case where the heat sink HS2 is formed of aluminum is described as an example, but the present disclosure is not limited to such an aspect. The heat sink HS2 may be formed of copper. The copper substrate is adopted as the analog conversion circuit substrate 502, and the heat sink HS2 is formed of copper, and thus the occurrence of corrosion between the heat sink HS2 and the analog conversion circuit substrate 502 may be prevented.

### B. 2. Modification Example 2

In the above-described embodiment and Modification Example 1, a case where the transistor substrate 501 is an aluminum substrate in which the base material 75 is formed of aluminum is described as an example, but the present disclosure is not limited to such an aspect. The transistor substrate 501 may be a copper substrate in which the base material 75 is formed of copper. The transistor substrate 501 may be a metal substrate in which a base material is formed of a metal.

In addition, in the above-described embodiment, a case where the heat sink HS1 is formed of aluminum is described as an example, but the present disclosure is not limited to such an aspect. The heat sink HS1 may be formed of copper. The copper substrate is adopted as the transistor substrate 501, and the heat sink HS1 is formed of copper, and thus the occurrence of corrosion between the heat sink HS1 and the base material 75 may be prevented.

### B. 3. Modification Example 3

In the above-described embodiment and Modification Examples 1 and 2, in the drive signal generation circuit 50, an aspect where one transistor pair 52 is provided corresponding to one analog conversion circuit 51 is described as an example, but the present disclosure is not limited to such an aspect. A plurality of transistor pairs 52 may be provided corresponding to one analog conversion circuit 51.

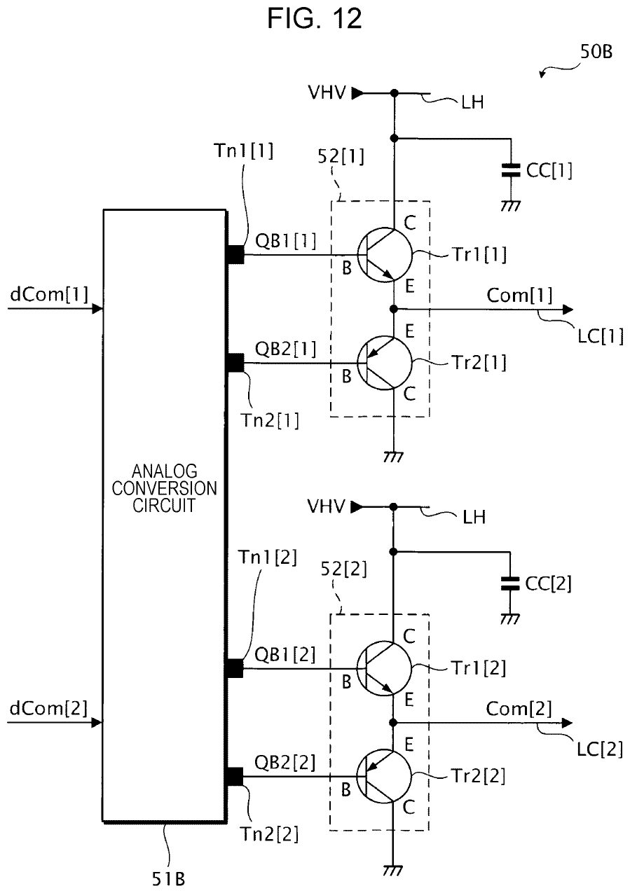

FIG. 12 is a block diagram illustrating an example of a circuit configuration of a drive signal generation circuit 50B according to the present modification example. The ink jet printer according to the present modification example is configured in the same manner as the ink jet printer 1 according to the embodiment, except that a drive signal generation circuit 50B is provided instead of the drive signal generation circuit 50.

As illustrated in FIG. 12, the drive signal generation circuit 50B is different from the drive signal generation circuit 50 according to the embodiment in that an analog conversion circuit 51B is provided instead of the analog conversion circuit 51, a plurality of transistor pairs 52[1] to 52[K] are provided instead of the transistor pair 52, and a plurality of electrolytic capacitors CC[1] to CC[K] are provided instead of the electrolytic capacitor CC. Here, a value K is a natural number that satisfies “K≥1”. In the following, among the K transistor pairs 52 provided in the drive signal generation circuit 50B, the k-th transistor pair 52 may be referred to as a transistor pair 52[k]. In addition, in the following, among the K electrolytic capacitors CC provided in the drive signal generation circuit 50B, the k-th electrolytic capacitor CC may be referred to as an electrolytic capacitor CC[k]. Here, a variable k is a natural number that satisfies “1≤k≤K”. In the following, as illustrated in FIG. 12, a case where a value K is “2” will be described as an example.

The analog conversion circuit 51B outputs the waveform designation signal QB[k] including the base supply signal QB1[k] and the base supply signal QB2[k] based on the digital waveform designation signal dCom[k]. The analog conversion circuit 51B outputs the base supply signal QB1[k] from the output terminal Tn1[k] and outputs the base supply signal QB2[k] from the output terminal Tn2[k].

In the present modification example, it is assumed that the waveform designation signal dCom[1] and the waveform designation signal dCom[2] are signals that designate waveforms different from each other, but the present disclosure is not limited to such an aspect. The waveform designation signal dCom[1] and the waveform designation signal dCom[2] may be signals that designate the same waveform as each other.

In addition, in the present modification example, it is assumed that the analog conversion circuit 51B generates the waveform designation signals QB[1] to QB[K] based on the waveform designation signals dCom[1] to dCom[K], but the present disclosure is not limited to such an aspect. The analog conversion circuit 51B may generate the waveform designation signals QB[1] to QB[K] having substantially the same waveform as each other based on the single waveform designation signal dCom.

The transistor pair 52[k] is provided with an NPN-type bipolar transistor Tr1[k] and a PNP-type bipolar transistor Tr2[k], and generates the drive signal Com[k] based on the base supply signal QB1[k] and the base supply signal QB2[k].

In the bipolar transistor Tr1[k], the base electrode (B) is electrically coupled to the output terminal Tn1[k], and the base supply signal QB1[k] is supplied from the output terminal Tn1[k]. In addition, in the bipolar transistor Tr1[k], the collector electrode (C) is electrically coupled to the power supply line LH in which the power supply potential VHV is set, and the emitter electrode (E) is electrically coupled to the wiring LC[k] for supplying the drive signal Com[k].

In the bipolar transistor Tr2[k], the base electrode (B) is electrically coupled to the output terminal Tn2[k], and the base supply signal QB2[k] is supplied from the output terminal Tn2[k]. In addition, in the bipolar transistor Tr2[k], the collector electrode (C) is electrically coupled to the ground, and the emitter electrode (E) is electrically coupled to the wiring LC[k] for supplying the drive signal Com[k].

The electrolytic capacitor CC[k] is a capacitor for supplying a current to the transistor pair 52[k]. Specifically, in the electrolytic capacitor CC[k], one electrode of the two electrodes of the electrolytic capacitor CC[k] is electrically coupled to the power supply line LH and the collector electrode of the bipolar transistor Tr1[k], and the other electrode is electrically coupled to the ground.

As described above, according to the present modification example, the plurality of transistor pairs 52[k] can be driven by the single analog conversion circuit 51B. In addition, in the present modification example, the analog conversion circuit 51B is cooled by the analog conversion circuit cooling mechanism CL2. Therefore, in the present modification example, even when the amount of current of the base current supplied from the analog conversion circuit 51B to the plurality of transistor pairs 52[k] increases, the temperature rise of the analog conversion circuit 51B can be prevented.

### B. 4. Modification Example 4

In the above-described embodiment and Modification Examples 1 to 3, a case where the fan FN1 maintains the operating state regardless of the temperature of the transistor pair 52 provided on the transistor substrate 501 and the fan FN2 maintains the operating state regardless of the temperature of the analog conversion circuit 51 provided on the analog conversion circuit substrate 502 are described as an example. However, the present disclosure is not limited to such an aspect. The fan FN1 may be driven based on the temperature of the transistor pair 52 provided on the transistor substrate 501. In addition, the fan FN2 may be driven based on the temperature of the analog conversion circuit 51 provided on the analog conversion circuit substrate 502.

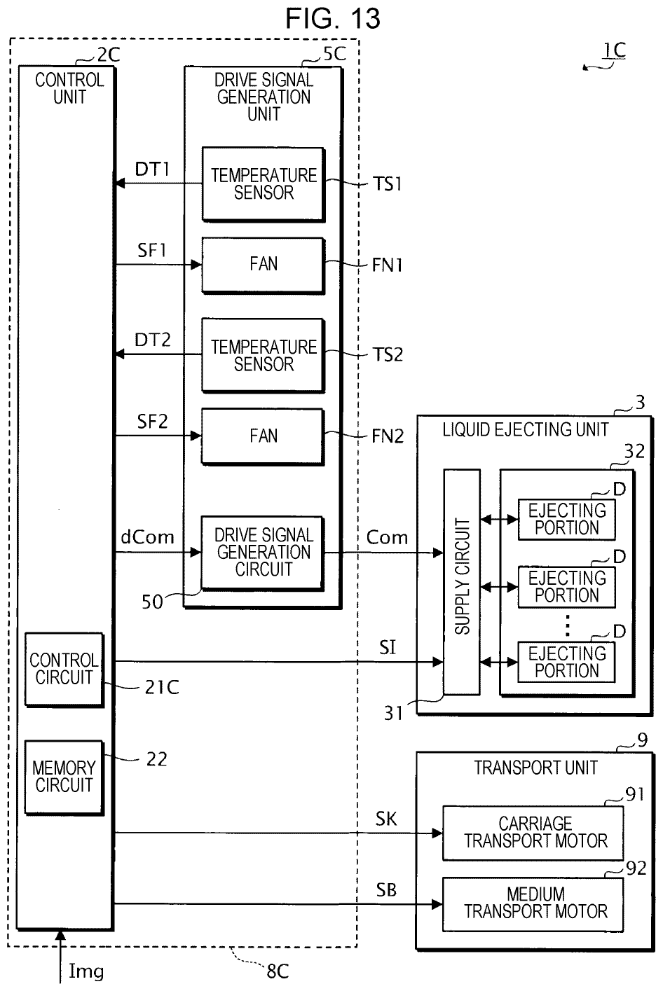

FIG. 13 is a functional block diagram illustrating an example of a configuration of an ink jet printer 1C according to the present modification example.

As illustrated in FIG. 13, the ink jet printer 1C is configured in the same manner as the ink jet printer 1 according to the embodiment, except that a control unit 2C is provided instead of the control unit 2 and a drive signal generation unit 5C is provided instead of the drive signal generation unit 5. In the present modification example, the configuration including the control unit 2C and the drive signal generation unit 5C is referred to as a drive control unit 8C. In the present modification example, the drive control unit 8C is an example of the “drive device”.

The drive signal generation unit 5C is different from the drive signal generation unit 5 according to the embodiment in that the drive signal generation unit 5C is provided with a temperature sensor TS1 and a temperature sensor TS2. The temperature sensor TS1 includes, for example, a thermistor provided on the transistor substrate 501, and outputs temperature information DT1 indicating the temperature TT1 based on the temperature of the transistor pair 52. The temperature sensor TS2 includes, for example, a thermistor provided on the analog conversion circuit substrate 502, and outputs temperature information DT2 indicating the temperature TT2 based on the temperature of the analog conversion circuit 51.

The control unit 2C is different from the control unit 2 according to the embodiment in that a control circuit 21C is provided instead of the control circuit 21.

The control circuit 21C generates a fan control signal SF1 that designates the fan FN1 to be driven or stopped based on the temperature TT1 indicated by the temperature information DT1. As a result, the control circuit 21C operates the fan FN1 based on the temperature TT1. More specifically, in the present modification example, the control circuit 21C generates a fan control signal SF1 that designates the operation of the fan FN1 when the temperature TT1 is equal to or higher than the predetermined temperature, and generates a fan control signal SF1 that designates the fan FN1 to be stopped when the temperature TT1 is lower than the predetermined temperature. Meanwhile, the present disclosure is not limited to such an aspect. For example, the control circuit 21C may generate a fan control signal SF1 that designates the operation of the fan FN1 when a subtraction value obtained by subtracting the atmospheric temperature of the ink jet printer 1C from the temperature TT1 is equal to or greater than a predetermined threshold value, and may generate a fan control signal SF1 that designates the fan FN1 to be stopped when a subtraction value obtained by subtracting the atmospheric temperature of the ink jet printer 1C from the temperature TT1 is less than the predetermined threshold value. In this case, the ink jet printer 1C may be provided with a temperature sensor (not illustrated) that measures the atmospheric temperature of the ink jet printer 1C.

The control circuit 21C generates a fan control signal SF2 that designates the fan FN2 to be driven or stopped based on the temperature TT2 indicated by the temperature information DT2. As a result, the control circuit 21C operates the fan FN2 based on the temperature TT2. More specifically, in the present modification example, the control circuit 21C generates a fan control signal SF2 that designates the operation of the fan FN2 when the temperature TT2 is equal to or higher than the predetermined temperature, and generates a fan control signal SF2 that designates the fan FN2 to be stopped when the temperature TT2 is lower than the predetermined temperature. Meanwhile, the present disclosure is not limited to such an aspect. For example, the control circuit 21C may generate a fan control signal SF2 that designates the operation of the fan FN2 when a subtraction value obtained by subtracting the atmospheric temperature of the ink jet printer 1C from the temperature TT2 is equal to or greater than a predetermined threshold value, and may generate a fan control signal SF2 that designates the fan FN2 to be stopped when the subtraction value obtained by subtracting the atmospheric temperature of the ink jet printer 1C from the temperature TT2 is less than the predetermined threshold value. In this case, the ink jet printer 1C may be provided with a temperature sensor (not illustrated) that measures the atmospheric temperature of the ink jet printer 1C.

As described above, according to the present modification example, the fan FN1 can be operated based on the temperature of the transistor pair 52, and the fan FN2 can be operated based on the temperature of the analog conversion circuit 51. Therefore, the amount of power required for operating the fan FN1 and the fan FN2 can be reduced as compared with an aspect where the fan FN1 and the fan FN2 are always operated.

### B. 5. Modification Example 5

In the above-described embodiment and Modification Examples 1 to 4, a case where the transistor substrate 501 and the analog conversion circuit substrate 502 are fixed to each other by the substrate-to-substrate connector CN1 is described as an example, but the present disclosure is not limited to such an aspect. The transistor substrate 501 and the analog conversion circuit substrate 502 may be fixed to each other by a pin header. Here, the pin header is a connector that includes an insertion pin member having a plurality of insertion pins formed of metal and a holding portion holding the plurality of insertion pins in a state of being insulated from each other, and a pin socket having a plurality of insertion holes provided corresponding to the plurality of insertion pins.

In the present modification example, it is assumed that the insertion pin member is fixed to the surface PL11 of the transistor substrate 501 among the pin headers, and the pin socket is fixed to the surface PL22 of the analog conversion circuit substrate 502 among the pin headers. The pin header fits the insertion pin member and the pin socket to fix the transistor substrate 501 and the analog conversion circuit substrate 502, and transmits a signal between the transistor substrate 501 and the analog conversion circuit substrate 502.

### B. 6. Modification Example 6

In the above-described embodiment and Modification Examples 1 to 5, a case where the transistor cooling mechanism CL1 is provided with the heat sink HS1 and the fan FN1 is described as an example, but the present disclosure is not limited to such an aspect. The transistor cooling mechanism CL1 may be provided with a water-cooled cooling device.

In addition, in the above-described embodiment and Modification Examples 1 to 5, a case where the analog conversion circuit cooling mechanism CL2 is provided with the heat sink HS2 and the fan FN2 is described as an example, but the present disclosure is not limited to such an aspect. The analog conversion circuit cooling mechanism CL2 may be provided with a water-cooled cooling device.

### B. 7. Modification Example 7

In the above-described embodiment and Modification Examples 1 to 6, an aspect where the control unit 2 is mounted on the carriage 110 as the drive control unit 8 is described as an example, but the present disclosure is not limited to such an aspect. The control unit 2 may be provided separately from the drive control unit 8. In this case, the control unit 2 may be provided outside the carriage 110.

### B. 8. Modification Example 8

In the above-described embodiment and Modification Examples 1 to 7, a case where the drive control unit 8 is mounted on the carriage 110 is described as an example, but the present disclosure is not limited to such an aspect. The drive control unit 8 may be provided outside the carriage 110.

### B. 9. Modification Example 9

In the above-described embodiment and Modification Examples 1 to 8, it is assumed that the ink jet printer 1 is a serial printer is described, the present disclosure is not limited to such an aspect. The ink jet printer 1 may be a so-called line printer in which a plurality of nozzles N are provided in the liquid ejecting unit 3 to extend wider than the width of the recording paper PP.

### C. Appendix

The aspects related to the above description are added below. In order to facilitate understanding of each aspect, in the following, reference signs in the drawings are given in parentheses for convenience, but the present disclosure is not limited to the illustrated aspect.

### C. 1. Appendix 1

Hereinafter, an ink jet printer 1 according to Appendix 1 will be described.

### Appendix 1-1

An ink jet printer 1 according to Appendix 1-1 includes a liquid ejecting unit 3 that is driven by a drive signal Com to eject ink, an analog conversion circuit 51 that converts a digital waveform designation signal dCom designating a waveform of the drive signal Com into an analog waveform designation signal QB designating the waveform of the drive signal Com, a transistor pair 52 that includes two bipolar transistors Tr generating the drive signal Com based on the waveform designation signal QB, a transistor cooling mechanism CL1 that cools the transistor pair 52, and an analog conversion circuit cooling mechanism CL2 that cools the analog conversion circuit 51.

In Appendix 1-1, the drive signal Com is an example of a “first drive signal”, and the transistor pair 52 is an example of a “first transistor pair”.

According to Appendix 1-1, since the analog conversion circuit cooling mechanism CL2 is provided separately from the transistor cooling mechanism CL1, the temperature rise of the analog conversion circuit 51 can be prevented, as compared with an aspect where both the analog conversion circuit 51 and the transistor pair 52 are cooled by a single cooling mechanism. Therefore, according to Appendix 1-1, the instability of the operation of the analog conversion circuit 51 caused by the temperature rise of the analog conversion circuit 51 can be prevented.

### Appendix 1-2

An ink jet printer 1 according to Appendices 1-2 is the ink jet printer 1 according to Appendix 1-1, in which an output terminal Tn1 of the analog conversion circuit 51 is electrically coupled to a base electrode 62B of the bipolar transistor Tr.

According to Appendix 1-2, even when the drive signal Com is a signal having a large amplitude and the base current supplied from the analog conversion circuit 51 to the transistor pair 52 is a large current, the temperature rise of the analog conversion circuit 51 can be prevented. Therefore, the instability of the operation of the analog conversion circuit 51 caused by the temperature rise of the analog conversion circuit 51 can be prevented.

### Appendix 1-3

An ink jet printer 1 according to Appendix 1-3 is the ink jet printer 1 according to Appendix 1-1 or 1-2, in which the analog conversion circuit cooling mechanism CL2 includes a heat sink HS2 coupled to the analog conversion circuit 51 or an analog conversion circuit substrate 502 on which the analog conversion circuit 51 is mounted, and a fan FN2 that operates based on the temperature of the analog conversion circuit 51.

According to Appendix 1-3, the temperature rise of the analog conversion circuit 51 can be prevented.

### Appendix 1-4

An ink jet printer 1 according to Appendix 1-4 is the ink jet printer 1 according to Appendices 1-1 to 1-3, and further includes a transistor substrate 501 provided with the transistor pair 52, an analog conversion circuit substrate 502 provided with the analog conversion circuit 51, a control circuit 21 that generates the waveform designation signal dCom, and a control substrate 200 provided with the control circuit 21, in which the control substrate 200 is provided to be separated from the analog conversion circuit substrate 502.

According to Appendix 1-4, the temperature rise of the control substrate 200 can be prevented, as compared with an aspect where the control substrate 200 and the analog conversion circuit substrate 502 have the same substrate.

### Appendix 1-5

An ink jet printer 1 according to Appendix 1-5 is the ink jet printer 1 according to Appendix 1-4, in which the analog conversion circuit substrate 502 and the control substrate 200 are coupled by a substrate-to-substrate connector CN2.

According to Appendix 1-5, even when the analog conversion circuit substrate 502 and the control substrate 200 vibrate, for example, when the analog conversion circuit substrate 502 and the control substrate 200 are mounted on the carriage 110 that moves within the ink jet printer 1, a state in which the analog conversion circuit substrate 502 and the control substrate 200 are stably coupled can be maintained.

### Appendix 1-6

An ink jet printer 1 according to Appendix 1-6 is the ink jet printer 1 according to Appendix 1-4 or Appendix 1-5, in which the analog conversion circuit substrate 502 is provided to be separated from the transistor substrate 501.

According to Appendix 1-6, the propagation of the heat generated in the transistor pair 52 to the analog conversion circuit 51 can be prevented, as compared with an aspect where the analog conversion circuit 51 is provided on the same substrate as the transistor pair 52. Therefore, according to Appendix 1-6, the temperature rise of the analog conversion circuit 51 can be prevented and the instability of the operation of the analog conversion circuit 51 can be prevented.

### Appendix 1-7

An ink jet printer 1 according to Appendix 1-7 is the ink jet printer 1 according to Appendices 1-4 to 1-6, in which the transistor substrate 501 and the analog conversion circuit substrate 502 are coupled by a substrate-to-substrate connector CN1.

According to Appendix 1-7, even when the transistor substrate 501 and the analog conversion circuit substrate 502 vibrate, for example, when the transistor substrate 501 and the analog conversion circuit substrate 502 are mounted on the carriage 110 that moves within the ink jet printer 1, a state in which the transistor substrate 501 and the analog conversion circuit substrate 502 are stably coupled can be maintained.

### Appendix 1-8

An ink jet printer 1 according to Appendix 1-8 is the ink jet printer 1 according to Appendices 1-4 to 1-6, in which the transistor substrate 501 and the analog conversion circuit substrate 502 are coupled by a pin header.

According to Appendix 1-8, even when the transistor substrate 501 and the analog conversion circuit substrate 502 vibrate, for example, when the transistor substrate 501 and the analog conversion circuit substrate 502 are mounted on the carriage 110 that moves within the ink jet printer 1, a state in which the transistor substrate 501 and the analog conversion circuit substrate 502 are stably coupled can be maintained.

### Appendix 1-9

An ink jet printer 1 according to Appendix 1-9 is the ink jet printer 1 according to Appendices 1-1 to 1-8, and further includes a transistor substrate 501 provided with the transistor pair 52, in which the bipolar transistor Tr is provided on the transistor substrate 501 such that a surface 600 having the largest area among a plurality of surfaces included in the bipolar transistor Tr is coupled to the transistor substrate 501.

According to Appendix 1-9, since the surface 600 having the largest area among the plurality of surfaces included in the bipolar transistor Tr is coupled to the transistor substrate 501, heat generated in the bipolar transistor Tr can be efficiently dissipated, as compared with an aspect where the surface having the smallest area among the plurality of surfaces included in the bipolar transistor Tr is coupled to the transistor substrate 501, or an aspect where the plurality of surfaces included in the bipolar transistor Tr are not coupled to the transistor substrate 501, for example.

### Appendix 1-10

An ink jet printer 1 according to Appendix 1-10 includes a liquid ejecting unit 3 that is driven by a drive signal Com[1] and a drive signal Com[2] to eject ink, an analog conversion circuit 51B that converts a digital waveform designation signal dCom[1] designating a waveform of the drive signal Com[1] into an analog waveform designation signal QB[1] designating the waveform of the drive signal Com[1], and converts a digital waveform designation signal dCom[2] designating a waveform of the drive signal Com[2] into an analog waveform designation signal QB[2] designating the waveform of the drive signal Com[2], a transistor pair 52[1] that includes two bipolar transistors Tr generating the drive signal Com[1] based on the waveform designation signal QB[1], a transistor pair 52[2] that includes two bipolar transistors Tr generating the drive signal Com[2] based on the waveform designation signal QB[2], a transistor cooling mechanism CL1 that cools the transistor pair 52[1] and the transistor pair 52[2], and an analog conversion circuit cooling mechanism CL2 that cools the analog conversion circuit 51B.

In Appendix 1-10, the drive signal Com[1] is an example of a “first drive signal”, the drive signal Com[2] is an example of a “second drive signal”, the transistor pair 52[1] is an example of a “first transistor pair”, the transistor pair 52[2] is an example of a “second transistor pair”, the waveform designation signal dCom[1] is an example of a “first waveform signal”, the waveform designation signal QB[1] is an example of a “second waveform signal”, the waveform designation signal dCom[2] is an example of a “third waveform signal”, and the waveform designation signal QB[2] is an example of a “fourth waveform signal”.

According to Appendix 1-10, even when the base current supplied from the analog conversion circuit 51B to the transistor pair 52[1] and the transistor pair 52[2] is a large current, the temperature rise of the analog conversion circuit 51B can be prevented. Therefore, the instability of the operation of the analog conversion circuit 51B caused by the temperature rise of the analog conversion circuit 51B can be prevented.

In Appendix 1-10, the waveform designation signal dCom[1] and the waveform designation signal dCom[2] may be the same signal (waveform designation signal dCom).

### Appendix 1-11

An ink jet printer 1 according to Appendix 1-11 is the ink jet printer 1 according to Appendices 1-1 to 1-10, in which the transistor cooling mechanism CL1 includes a heat sink HS1 coupled to a transistor substrate 501 on which the transistor pair 52 is mounted and formed of aluminum, and the analog conversion circuit cooling mechanism CL2 includes a heat sink HS2 coupled to the analog conversion circuit 51 or the analog conversion circuit substrate 502 on which the analog conversion circuit 51 is mounted and formed of copper.

According to Appendix 1-11, the temperature rise of the analog conversion circuit 51 can be prevented and the instability of the operation of the analog conversion circuit 51 can be prevented.

### Appendix 1-12

An ink jet printer 1 according to Appendix 1-12 is the ink jet printer 1 according to Appendices 1-1 to 1-11, in which the transistor cooling mechanism CL1 includes a water-cooled cooling device.

According to Appendix 1-12, the temperature rise of the transistor pair 52 can be prevented.

### C. 2. Appendix 2

Hereinafter, an ink jet printer 1 according to Appendix 2 will be described.

### Appendix 2-1

An ink jet printer 1 according to Appendix 2-1 includes a liquid ejecting unit 3 that is driven by a drive signal Com to eject ink, a transistor substrate 501, a transistor pair 52 that is provided on the transistor substrate 501 and includes two bipolar transistors Tr generating the drive signal Com, an analog conversion circuit substrate 502, and an analog conversion circuit 51 that is provided on the analog conversion circuit substrate 502 and converts a digital waveform designation signal dCom designating a waveform of the drive signal Com into an analog waveform designation signal QB designating the waveform of the drive signal Com, in which the transistor pair 52 generates the drive signal Com based on the waveform designation signal QB, and the analog conversion circuit substrate 502 is provided to be separated from the transistor substrate 501.

According to Appendix 2-1, the transistor substrate 501 provided with the transistor pair 52 and the analog conversion circuit substrate 502 provided with the analog conversion circuit 51 are provided to be separated. Therefore, the propagation of heat generated in the transistor pair 52 to the analog conversion circuit 51 can be prevented, as compared with an aspect where the analog conversion circuit 51 is provided on the same substrate as the transistor pair 52. Therefore, according to Appendix 2-1, the temperature rise of the analog conversion circuit 51 at the time of generating the drive signal Com can be prevented, and the instability of the operation of the analog conversion circuit 51 caused by the temperature rise of the analog conversion circuit 51 can be prevented.

### Appendix 2-2

An ink jet printer 1 according to Appendix 2-2 is the ink jet printer 1 according to Appendix 2-1, and further includes a transistor cooling mechanism CL1 that cools the transistor pair 52.

According to Appendix 2-2, the temperature rise of the transistor pair 52 can be prevented, and thus the temperature rise of the analog conversion circuit 51 caused by the propagation of the heat generated in the transistor pair 52 to the analog conversion circuit 51 can be prevented.

### Appendix 2-3

An ink jet printer 1 according to Appendix 2-3 is the ink jet printer 1 according to Appendix 2-1 or Appendix 2-2, in which the transistor substrate 501 includes a surface PL11 and a surface PL12 opposite to the surface PL11, the electronic components including the transistor pair 52 are disposed on the surface PL11, and the transistor cooling mechanism CL1 is disposed on the surface PL12.

In Appendix 2-3, the surface PL11 is an example of a “first surface”, and the surface PL12 is an example of a “second surface”.

According to Appendix 2-3, the temperature rise of the transistor pair 52 can be prevented, and thus the temperature rise of the analog conversion circuit 51 caused by the propagation of the heat generated in the transistor pair 52 to the analog conversion circuit 51 can be prevented.

### Appendix 2-4

An ink jet printer 1 according to Appendices 2-4 is the ink jet printer 1 according to Appendix 2-2 or Appendix 2-3, in which the transistor cooling mechanism CL1 includes a heat sink HS1 coupled to a base material 75 of the transistor substrate 501 and a fan FN1 that operates based on the temperature of the transistor pair 52.

According to Appendix 2-4, the temperature rise of the transistor pair 52 can be prevented, and thus the temperature rise of the analog conversion circuit 51 caused by the propagation of the heat generated in the transistor pair 52 to the analog conversion circuit 51 can be prevented.

### Appendix 2-5

An ink jet printer 1 according to Appendix 2-5 is the ink jet printer 1 according to Appendices 2-1 to 2-3, in which the analog conversion circuit substrate 502 is provided with an electrolytic capacitor CC that supplies the current to the transistor pair 52.

According to Appendix 2-5, the propagation of the heat generated in the transistor pair 52 to the electrolytic capacitor CC can be prevented, as compared with an aspect where the electrolytic capacitor CC is provided on the same substrate as the transistor pair 52. Therefore, according to Appendix 2-5, the deterioration of the electrolytic capacitor CC due to heat can be prevented and the increase of the life of the electrolytic capacitor CC can be achieved, as compared with an aspect where the electrolytic capacitor CC is provided on the same substrate as the transistor pair 52.

### Appendix 2-6

An ink jet printer 1 according to Appendix 2-6 is the ink jet printer 1 according to Appendices 2-1 to 2-5, in which the transistor substrate 501 and the analog conversion circuit substrate 502 are coupled by a substrate-to-substrate connector CN1.

According to Appendix 2-6, even when the transistor substrate 501 and the analog conversion circuit substrate 502 vibrate, for example, when the transistor substrate 501 and the analog conversion circuit substrate 502 are mounted on the carriage 110 that moves within the ink jet printer 1, a state in which the transistor substrate 501 and the analog conversion circuit substrate 502 are stably coupled can be maintained.

### Appendix 2-7

An ink jet printer 1 according to Appendix 2-7 is the ink jet printer 1 according to Appendices 2-1 to 2-5, in which the transistor substrate 501 and the analog conversion circuit substrate 502 are coupled by a pin header.

According to Appendix 2-7, even when the transistor substrate 501 and the analog conversion circuit substrate 502 vibrate, for example, when the transistor substrate 501 and the analog conversion circuit substrate 502 are mounted on the carriage 110 that moves within the ink jet printer 1, a state where the transistor substrate 501 and the analog conversion circuit substrate 502 are stably coupled can be maintained.

### Appendix 2-8

An ink jet printer 1 according to Appendix 2-8 is the ink jet printer 1 according to Appendices 2-1 to 2-7, and further includes a connector (substrate-to-substrate connector CN1 or pin header) that couples the transistor substrate 501 and the analog conversion circuit substrate 502, in which the connector is disposed in a central region AM of the transistor substrate 501.

In Appendix 2-8, the central region AM is an example of the “central portion”.

According to Appendix 2-8, even when the transistor substrate 501 and the analog conversion circuit substrate 502 vibrate, for example, when the transistor substrate 501 and the analog conversion circuit substrate 502 are mounted on the carriage 110 that moves within the ink jet printer 1, a state in which the transistor substrate 501 and the analog conversion circuit substrate 502 are stably coupled can be maintained.

### Appendix 2-9

An ink jet printer 1 according to Appendix 2-9 is the ink jet printer 1 according to Appendices 2-1 to 2-8, in which the transistor substrate 501 includes a long side LY1 and a long side LY2 facing each other, and a short side LX1 and a short side LX2 facing each other, a plurality of transistor pairs 52 are provided on the transistor substrate 501, and the plurality of bipolar transistors Tr included in the plurality of transistor pairs 52 are disposed to be aligned along the long side LY1 and the long side LY2.

According to Appendix 2-9, heat generated in the plurality of bipolar transistors Tr can be efficiently dissipated from the long side LY1 and the long side LY2.

### Appendix 2-10

An ink jet printer 1 according to Appendix 2-10 is the ink jet printer 1 according to Appendices 2-1 to 2-9, in which the bipolar transistor Tr is provided on the transistor substrate 501 such that a surface 600 having the largest area among a plurality of surfaces included in the bipolar transistor Tr is coupled to the transistor substrate 501.

According to Appendix 2-10, since the surface 600 having the largest area among the plurality of surfaces included in the bipolar transistor Tr is coupled to the transistor substrate 501, heat generated in the bipolar transistor Tr can be efficiently dissipated, as compared with an aspect where the surface having the smallest area among the plurality of surfaces included in the bipolar transistor Tr is coupled to the transistor substrate 501, or an aspect where the plurality of surfaces included in the bipolar transistor Tr are not coupled to the transistor substrate 501, for example.

### Appendix 2-11

An ink jet printer 1 according to Appendix 2-11 is the ink jet printer 1 according to Appendices 2-1 to 2-10, in which the transistor substrate 501 includes a surface PL11 and a surface PL12 opposite to the surface PL11, the bipolar transistor Tr is disposed on the surface PL11, the transistor cooling mechanism CL1 that cools the bipolar transistor Tr is disposed on the surface PL12, and the bipolar transistor Tr is fixed to the transistor cooling mechanism CL1 by a screw 65 that penetrates the transistor substrate 501.

According to Appendix 2-11, the heat generated from the bipolar transistor Tr can be dissipated to the transistor cooling mechanism CL1 via the screw 65, and thus the temperature rise of the bipolar transistor Tr can be prevented.

### C. 3. Appendix 3

Hereinafter, an ink jet printer 1 according to Appendix 3 will be described.

### Appendix 3-1

An ink jet printer 1 according to Appendix 3-1 includes a liquid ejecting unit 3 that is driven by a drive signal Com to eject ink, a metal transistor substrate 501, and a transistor pair 52 that is provided on the transistor substrate 501 and includes two bipolar transistors Tr generating the drive signal Com.

According to Appendix 3-1, since the transistor pair 52 is provided on the metal transistor substrate 501, heat generated in the transistor pair 52 can be efficiently dissipated, as compared with an aspect where the transistor pair 52 is provided on a resin substrate, for example. Therefore, according to Appendix 3-1, the temperature rise of the transistor pair 52 can be prevented.

### Appendix 3-2

An ink jet printer 1 according to Appendix 3-2 is the ink jet printer 1 according to Appendix 3-1, and further includes a carriage 110 that moves the liquid ejecting unit 3, in which the transistor substrate 501 has a base material 75 formed of aluminum, and is mounted on the carriage 110.

According to Appendix 3-2, since the aluminum substrate having an aluminum base material is adopted as the transistor substrate 501, the weight of the transistor substrate 501 can be reduced, as compared with an aspect where a substrate having a copper base material is adopted as the transistor substrate 501, for example. Therefore, according to Appendix 3-2, the load on the carriage transport motor 91 that moves the carriage 110 on which the transistor substrate 501 is mounted can be reduced, the life of the carriage transport motor 91 can be increased, and the amount of power required for driving the carriage transport motor 91 can be reduced.

### Appendix 3-3

An ink jet printer 1 according to Appendix 3-3 is the ink jet printer 1 according to Appendix 3-2, and further includes a heat sink HS1 coupled to the base material 75 of the transistor substrate 501 and formed of aluminum.

According to Appendix 3-3, the heat generated from the transistor pair 52 can be dissipated from the heat sink HS1, and thus the temperature rise of the transistor pair 52 can be prevented.

In addition, according to Appendix 3-3, since the heat sink HS1 is made of aluminum, the weight of the heat sink HS1 can be reduced as compared with a case where the heat sink HS1 is made of copper, for example. Therefore, according to Appendix 3-3, the life of the carriage transport motor 91 can be increased and the amount of power required for driving the carriage transport motor 91 can be reduced.

In addition, according to Appendix 3-3, the aluminum heat sink HS1 is coupled to the transistor substrate 501 having the aluminum base material 75. Therefore, the possibility of corrosion at the boundary between the transistor substrate 501 and the heat sink HS1 can be reduced, as compared with an aspect where a substrate having a copper base material is adopted as the transistor substrate 501 and the aluminum heat sink HS1 is coupled to the transistor substrate 501, for example. Therefore, according to Appendix 3-3, it is not necessary to interpose the heat dissipation sheet between the transistor substrate 501 and the heat sink HS1, and it is only necessary to interpose the grease 64 between the transistor substrate 501 and the heat sink HS1. As a result, according to Appendix 3-3, the size of the drive signal generation unit 5 including the transistor substrate 501 and the heat sink HS1 can be reduced, the cost of the drive signal generation unit 5 can be reduced, and the number of components of the drive signal generation unit 5 can be reduced, as compared with the aspect of adopting the substrate having a copper base material as the transistor substrate 501.

### Appendix 3-4

An ink jet printer 1 according to Appendix 3-4 is the ink jet printer 1 according to Appendices 3-1 to 3-3, and further includes a fan FN1 that operates based on the temperature of the transistor pair 52.

According to Appendix 3-4, heat generated from the transistor pair 52 can be dissipated by the fan FN1, and thus the temperature rise of the transistor pair 52 can be prevented.

### Appendix 3-5

An ink jet printer 1 according to Appendix 3-5 is the ink jet printer 1 according to Appendices 3-1 to 3-4, and further includes an analog conversion circuit substrate 502 and an analog conversion circuit 51 that is provided on the analog conversion circuit substrate 502 and converts the digital waveform designation signal dCom designating the waveform of the drive signal Com into the analog waveform designation signal QB designating the waveform of the drive signal Com, in which the transistor pair 52 generates the drive signal Com based on the waveform designation signal QB, and the analog conversion circuit substrate 502 is provided to be separated from the transistor substrate 501.

According to Appendix 3-5, since the analog conversion circuit substrate 502 is separated from the transistor substrate 501, the propagation of heat generated in the transistor pair 52 to the analog conversion circuit 51 can be prevented, as compared with an aspect where the analog conversion circuit 51 is provided on the same substrate as the transistor pair 52. Therefore, according to Appendix 3-5, the temperature rise of the analog conversion circuit 51 can be prevented and the instability of the operation of the analog conversion circuit 51 can be prevented.

### Appendix 3-6

An ink jet printer 1 according to Appendix 3-6 is the ink jet printer 1 according to Appendix 3-5, and further includes a transistor cooling mechanism CL1 that cools the transistor pair 52 and the analog conversion circuit cooling mechanism CL2 that cools the analog conversion circuit 51.

According to Appendix 3-6, since the analog conversion circuit cooling mechanism CL2 is provided separately from the transistor cooling mechanism CL1, the temperature rise of the analog conversion circuit 51 can be prevented, as compared with an aspect where both the analog conversion circuit 51 and the transistor pair 52 are cooled by a single cooling mechanism. Therefore, according to Appendix 3-6, the instability of the operation of the analog conversion circuit 51 caused by the temperature rise of the analog conversion circuit 51 can be prevented.

### Appendix 3-7

An ink jet printer 1 according to Appendix 3-7 is the ink jet printer 1 according to Appendices 3-1, in which the transistor substrate 501 includes a base material 75 formed of copper.

According to Appendix 3-7, since the transistor pair 52 is provided on the transistor substrate 501 having a copper base material, the heat generated in the transistor pair 52 can be effectively dissipated, as compared with an aspect where the transistor pair 52 is provided on the resin substrate, for example.

### Appendix 3-8

An ink jet printer 1 according to Appendix 3-8 is the ink jet printer 1 according to Appendices 3-1 to 3-7, in which the bipolar transistor Tr is provided on the transistor substrate 501 such that a surface 600 having the largest area among a plurality of surfaces included in the bipolar transistor Tr is coupled to the transistor substrate 501.

According to Appendix 3-8, since the surface 600 having the largest area among the plurality of surfaces included in the bipolar transistor Tr is coupled to the transistor substrate 501, heat generated in the bipolar transistor Tr can be efficiently dissipated, as compared with an aspect where the surface having the smallest area among the plurality of surfaces included in the bipolar transistor Tr is coupled to the transistor substrate 501, or an aspect where the plurality of surfaces included in the bipolar transistor Tr are not coupled to the transistor substrate 501, for example.

What is claimed is:

1. A liquid ejecting apparatus comprising:
a liquid ejecting head that is driven by a first drive signal to eject a liquid;
an analog conversion circuit that converts a digital first waveform signal designating a waveform of the first drive signal into an analog second waveform signal designating the waveform of the first drive signal;
a first transistor pair that includes two bipolar transistors generating the first drive signal based on the second waveform signal;
a first cooling mechanism that cools the first transistor pair; and
a second cooling mechanism that cools the analog conversion circuit.

2. The liquid ejecting apparatus according to claim 1, wherein
an output terminal of the analog conversion circuit is electrically coupled to a base electrode of the bipolar transistor.

3. The liquid ejecting apparatus according to claim 1, wherein
the second cooling mechanism includes
a heat sink coupled to the analog conversion circuit or a substrate on which the analog conversion circuit is mounted, and
a fan that operates based on a temperature of the analog conversion circuit.

4. The liquid ejecting apparatus according to claim 1, further comprising:
a first substrate provided with the first transistor pair;
a second substrate provided with the analog conversion circuit;
a control circuit that generates the first waveform signal; and
a third substrate provided with the control circuit, wherein
the third substrate is provided to be separated from the second substrate.

5. The liquid ejecting apparatus according to claim 4, wherein
the second substrate and the third substrate are coupled by a substrate-to-substrate connector.

6. The liquid ejecting apparatus according to claim 4, wherein
the second substrate is provided to be separated from the first substrate.

7. The liquid ejecting apparatus according to claim 6, wherein
the first substrate and the second substrate are coupled by a substrate-to-substrate connector.

8. The liquid ejecting apparatus according to claim 6, wherein
the first substrate and the second substrate are coupled by a pin header.

9. The liquid ejecting apparatus according to claim 1, further comprising:
a first substrate provided with the first transistor pair, wherein
the bipolar transistor is provided on the first substrate such that a largest surface among a plurality of surfaces included in the bipolar transistor is coupled to the first substrate.

10. The liquid ejecting apparatus according to claim 1, further comprising:
a second transistor pair that includes two bipolar transistors generating a second drive signal, wherein
the liquid ejecting head is driven by the second drive signal to eject a liquid,
the analog conversion circuit converts a digital third waveform signal designating a waveform of the second drive signal into an analog fourth waveform signal designating the waveform of the second drive signal,
the second transistor pair generates the second drive signal based on the fourth waveform signal, and
the first cooling mechanism cools the second transistor pair.

11. The liquid ejecting apparatus according to claim 1, wherein
the first cooling mechanism includes a first heat sink coupled to a substrate on which the first transistor pair is mounted and formed of aluminum, and
the second cooling mechanism includes a second heat sink coupled to the analog conversion circuit or a substrate on which the analog conversion circuit is mounted and formed of copper.

12. The liquid ejecting apparatus according to claim 1, wherein
the first cooling mechanism includes a water-cooled cooling device.

13. A drive device that supplies a first drive signal to a liquid ejecting head driven by the first drive signal to eject a liquid, the drive device comprising:
an analog conversion circuit that converts a digital first waveform signal designating a waveform of the first drive signal into an analog second waveform signal designating the waveform of the first drive signal;
a first transistor pair that includes two bipolar transistors generating the first drive signal based on the second waveform signal;
a first cooling mechanism that cools the first transistor pair; and
a second cooling mechanism that cools the analog conversion circuit.

14. The drive device according to claim 13, wherein
an output terminal of the analog conversion circuit is electrically coupled to a base electrode of the bipolar transistor.

15. The drive device according to claim 13, wherein
the second cooling mechanism includes
a heat sink coupled to the analog conversion circuit or a substrate on which the analog conversion circuit is mounted, and
a fan that operates based on a temperature of the analog conversion circuit.

16. The drive device according to claim 13, further comprising:
a first substrate provided with the first transistor pair;
a second substrate provided with the analog conversion circuit;
a control circuit that generates the first waveform signal; and
a third substrate provided with the control circuit, wherein
the third substrate is provided to be separated from the second substrate.

17. The drive device according to claim 16, wherein
the second substrate and the third substrate are coupled by a substrate-to-substrate connector.

18. The drive device according to claim 16, wherein
the second substrate is provided to be separated from the first substrate.

19. The drive device according to claim 18, wherein
the first substrate and the second substrate are coupled by a substrate-to-substrate connector.

20. The drive device according to claim 18, wherein
the first substrate and the second substrate are coupled by a pin header.

21. The drive device according to claim 13, further comprising:
a first substrate provided with the first transistor pair, wherein
the bipolar transistor is provided on the first substrate such that a largest surface among a plurality of surfaces included in the bipolar transistor is coupled to the first substrate.

22. The drive device according to claim 13, further comprising:
a second transistor pair that includes two bipolar transistors generating a second drive signal, wherein
the liquid ejecting head is driven by the second drive signal to eject a liquid,
the analog conversion circuit converts a digital third waveform signal designating a waveform of the second drive signal into an analog fourth waveform signal designating the waveform of the second drive signal,
the second transistor pair generates the second drive signal based on the fourth waveform signal, and
the first cooling mechanism cools the second transistor pair.

23. The drive device according to claim 13, wherein
the first cooling mechanism includes a first heat sink coupled to a substrate on which the first transistor pair is mounted and formed of aluminum, and
the second cooling mechanism includes a second heat sink coupled to the analog conversion circuit or a substrate on which the analog conversion circuit is mounted and formed of copper.

24. The drive device according to claim 13, wherein
the first cooling mechanism includes a water-cooled cooling device.
